(19) United States
(12) Patent Application Publication
(10) Pub. No.: US 2026/0247107 A1
(43) Pub. Date: Aug. 20, 2026

(54) LOCALIZATION TECHNIQUES FOR PLAYBACK DEVICES

(71) Applicant: Sonos, Inc., Goleta, CA (US)

(72) Inventors: James A. NESFIELD, Edinburgh (GB); Kurt T. SOTO, Ventura, CA (US); Matthew BENATAN, Stockport (GB); Gershon DUBLON, London (GB); Ian FRANK, Arlington, MA (US); Daniel JONES, London (GB)

(21) Appl. No.: 19/114,699

(22) PCT Filed: Sep. 25, 2023
(86) PCT No.: PCT/US2023/075027

§ 371 Date: Mar. 24, 2025

Related U.S. Application Data
(60) Provisional application No. 63/377,898, filed on Sep. 30, 2022.

(51) Int. Cl. H04W 4/029

(52) U.S. Cl. CPC H04W 4/029

(57) ABSTRACT

Network devices, systems, and methods for localizing portable playback devices. In one example, a method of determining a location of a docking station includes over a time period, receiving multiple instances of movement information from a portable playback device, over the time period, receiving multiple instances of detection information from at least one stationary playback device, the detection information indicating that the at least one stationary playback device has detected a presence of the portable playback device, estimating, based on at least a combination of the movement information and the detection information, the location of the docking station relative to the at least one stationary playback device, and storing the location of the docking station.

### CROSS-REFERENCE TO RELATED APPLICATIONS

This application claims priority under 35 U.S.C. § 119(e), PCT Article 8, and Article 4 of the Paris Convention to co-pending U.S. Provisional Patent Application No. 63/377,898 titled “LOCALIZATION OF PLAYBACK DEVICES VIA DEAD RECKONING” and filed on Sep. 30, 2022, which is hereby incorporated herein by reference in its entirety for all purposes.

### TECHNICAL FIELD

The present technology relates to consumer goods and, more particularly, to methods, systems, products, aspects, services, and other elements directed to media playback systems or some aspect thereof.

### BACKGROUND

Options for accessing and listening to digital audio in an out-loud setting were limited until in 2002, when Sonos, Inc. began development of a new type of playback system. Sonos then filed one of its first patent applications in 2003, titled “Method for Synchronizing Audio Playback between Multiple Networked Devices,” and began offering its first media playback systems for sale in 2005. The SONOS Wireless Home Sound System enables people to experience music from many sources via one or more networked playback devices. Through a software control application installed on a controller (e.g., a smartphone, tablet, computer, or voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

Given the ever-growing interest in digital media, there continues to be a need to develop consumer-accessible technologies to further enhance the listening experience.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this disclosure. However, the figures are not intended as a definition of the limits of any particular example. The figures, together with the remainder of this disclosure, serve to explain principles and operations of the described and claimed aspects. In the figures, the same or similar components that are illustrated are represented by a like reference numeral. For purposes of clarity, every component may not be labeled in every figure. In the figures:

FIG. 1A is a partial cutaway view of an environment having a media playback system configured in accordance with aspects of the disclosed technology;

FIG. 1B is a schematic diagram of the media playback system of FIG. 1A and one or more networks;

FIG. 2A is a functional block diagram of an example of a playback device;

FIG. 2B is an isometric diagram of an example of a housing of the playback device of FIG. 2A;

FIGS. 3A-3E are diagrams showing examples of playback device configurations in accordance with aspects of the disclosure;

FIG. 4A is a functional block diagram of an example of a controller device in accordance with aspects of the disclosure;

FIG. 5 is a functional block diagram of circuitry of an example of a network microphone device in accordance with aspects of the disclosure;

FIG. 6 is a conceptual diagram illustrating aspects of a positioning system architecture in accordance with aspects of the disclosure;

FIGS. 7A-C are diagrams illustrating an example of a media playback system environment in which a localization system and method may be implemented in accordance with aspects of the disclosure;

FIG. 8 is a sequence diagram illustrating one example of a localization method in accordance with aspects of the disclosure; and

FIG. 9 is a sequence diagram illustrating one example of automatic stereo pairing of a portable playback device with another playback device in according with aspects of the disclosure.

### DETAILED DESCRIPTION

### I. OVERVIEW

In conventional home theatre environments and even many home audio systems more general than home theatre environments, the audio players (e.g., speakers) typically reside in relatively fixed locations within the home or other space, which makes configuring and controlling the overall acoustic output from the system relatively straightforward. Once the locations of the players have been selected, they typically do not change (at least not frequently) and therefore the configuration of the players can be relatively static. However, as portable audio playback devices become more popular and widespread, there may be more and more circumstances in which it may be desirable to alter the configuration of a playback device based at least in part on its location. It may be particularly desirable to achieve this reconfiguration automatically, without requiring action (or at least not significant action) by a user. Accordingly, aspects and embodiments are directed to systems and methods for tracking the location of a portable playback device relative to one or more other playback devices in a media playback system (MPS) and automatically altering one or more configuration aspects or parameters of the portable playback device based on its location.

According to certain embodiments, a portable playback device may include a rechargeable power source, such as a rechargeable battery, that can be recharged by connecting the portable playback device to an electrical source. In some examples, the portable playback device can be associated with a dock that can be connected to an electrical source, such as a mains power outlet, for example, and can supply recharging power to the portable playback device when the portable playback device is installed on the dock (“docked”). In some instances, it may be desirable to alter one or more configuration aspects or parameters of the portable playback device based at least in part on whether or not the portable device is docked. For example, the dock may be placed in a fixed location relative to another playback device such that, when docked, the portable playback device and the other playback device are positioned to form a stereo pair. Therefore, according to certain embodiments, a positioning system may monitor for when a portable playback device is docked, determine a location of the dock, and based thereon, automatically alter a configuration aspect of the portable playback device and optionally one or more other playback devices (e.g., to cause the portable playback device to be bonded with one or more other playback devices or to form a stereo pair with another playback device, as discussed below). In some instances, the location of the dock may be determined based on a determined location of the portable playback device and an indication that the portable device is docked. In other instances, the location of the dock may be inferred from monitoring that the portable playback device returns to the same location periodically and remains at that location for a period of time (e.g., to complete a charging cycle). These and other examples are discussed in more detail below.

Thus, aspects and embodiments may provide enhanced functionality within a media playback system and enhanced user experiences through automatically monitoring and adapting to the changing relative location of a portable playback device with an environment covered by the media playback system. As discussed in more detail below, monitoring the movement of the portable playback device can be achieved by collecting movement information from the portable playback device itself and receiving notifications from other devices, such as other playback devices, a controller, or the like, when they detect the presence of the portable playback device. In some examples, movement information is collected through the use of “dead reckoning.” Dead reckoning refers to a navigation process in which the current location of a portable playback device is determined using a starting location and the speed(s), heading(s), and time(s) of movement since the portable playback device was at the starting location. Presence detection can be accomplished using any of a variety of wireless communications or sensing technologies, some examples of which are discussed further below.

According to certain embodiments, a playback device comprises a wireless communications interface configured to support communication of data via at least one network protocol, at least one processor, and at least one non-transitory computer-readable medium storing program instructions that are executable by the at least one processor such that the playback device is configured to, over time, periodically receive, via the wireless communications interface, movement information from a portable playback device, receive via the wireless communications interface, multiple instances of detection information from at least one stationary playback device, the detection information indicating that the at least one stationary playback device has detected a presence of the portable playback device, estimate a location of a docking station for the portable playback device based on at least the movement information and the detection information, and store the estimated location of the docking station in the at least one non-transitory computer-readable medium. The estimated location of the docking station can be refined and updated over time as the playback device acquires additional movement information and/or detection information.

While some examples described herein may refer to functions performed by given actors, such as “users,” “listeners,” and/or other entities, it should be understood that this description is for purposes of explanation only. The claims should not be interpreted to require action by any such example actor unless explicitly required by the language of the claims themselves.

### II. EXAMPLE OPERATING ENVIRONMENT

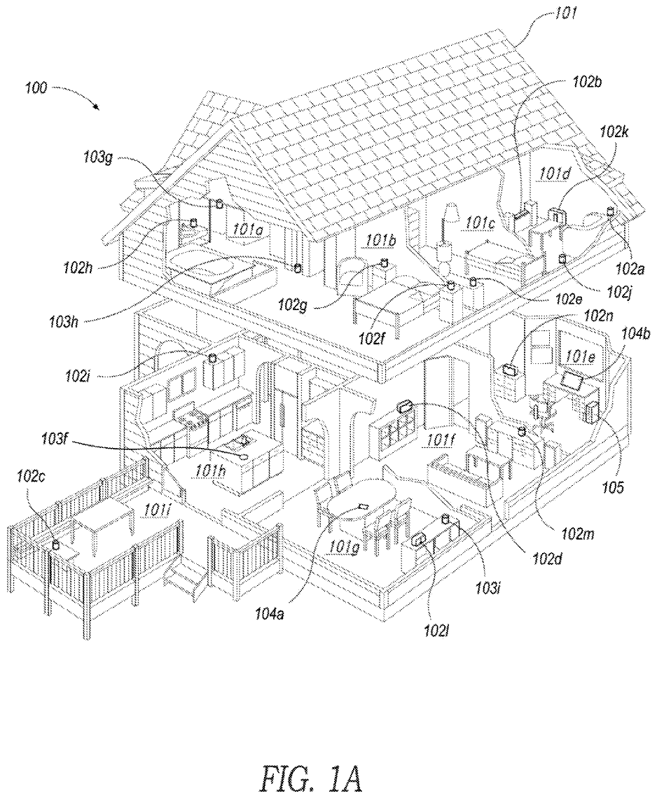

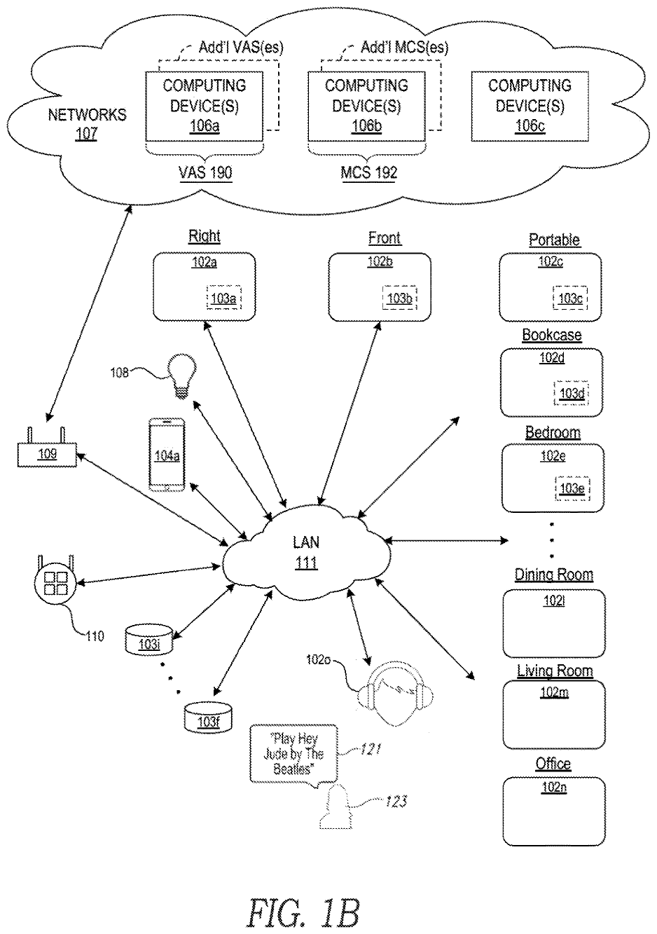

FIGS. 1A and 1B illustrate an example configuration of a media playback system 100 (or “MPS 100”) in which one or more examples disclosed herein may be implemented. Referring first to FIG. 1A, the MPS 100 as shown is associated with an example home environment having a plurality of rooms and spaces, which may be collectively referred to as a “home environment,” “smart home,” or “environment 101.” The environment 101 comprises a household having several rooms, spaces, and/or playback zones, including a master bathroom 101a, a master bedroom 101b (referred to herein as “Nick's Room”), a second bedroom 101c, a family room or den 101d, an office 101e, a living room 101f, a dining room 101g, a kitchen 101h, and an outdoor patio 101i. While certain aspects and examples are described below in the context of a home environment, the technologies described herein may be implemented in other types of environments. In some examples, for instance, the MPS 100 can be implemented in one or more commercial settings (e.g., a restaurant, mall, airport, hotel, a retail or other store), one or more vehicles (e.g., a sports utility vehicle, bus, car, a ship, a boat, an airplane, etc.), multiple environments (e.g., a combination of home and vehicle environments), and/or another suitable environment where multi-zone audio may be desirable.

Within these rooms and spaces, the MPS 100 includes one or more computing devices. Referring to FIGS. 1A and 1B together, such computing devices can include playback devices 102 (identified individually as playback devices 102a-102o), network microphone devices 103 (identified individually as “NMDs” 103a-103i), and controller devices 104a and 104b (collectively “controller devices 104”). Referring to FIG. 1B, the home environment may include additional and/or other computing devices, including local network devices, such as one or more smart illumination devices 108 (FIG. 1B), a smart thermostat 110, and a local computing device 105 (FIG. 1A).

As used herein the term “playback device” can generally refer to a network device configured to receive, process, and output data of a media playback system, such as the MPS 100. For example, a playback device 102 can be a network device that receives and processes audio content. In some embodiments, a playback device 102 includes one or more transducers or speakers powered by one or more amplifiers, as discussed further below. In other embodiments, however, a playback device 102 includes one of (or neither of) the speaker and the amplifier. For instance, a playback device 102 can comprise one or more amplifiers configured to drive one or more speakers external to the playback device 102 via a corresponding wire or cable.

As used herein the term NMD (i.e., a “network microphone device”) can generally refer to a networked computing device that is configured for audio detection. As such, the NMD 103 may include a microphone that is configured to detect sounds in the NMD's environment.

In various implementations, one or more of the playback devices 102 may take the form of or include an on-board (e.g., integrated) network microphone device. A playback device 102 that includes components and functionality of an NMD 103 may be referred to as being “NMD-equipped.” For example, the playback devices 102a-e include or are otherwise equipped with corresponding NMDs 103a-e, respectively. In some cases, one or more of the NMDs 103 may be a stand-alone device. For example, the NMDs 103f and 103g may be stand-alone devices. A stand-alone NMD may omit components and/or functionality that is typically included in a playback device, such as a speaker or related electronics. For instance, in such cases, a stand-alone NMD may not produce audio output or may produce limited audio output.

The term “control device” can generally refer to a network device configured to perform functions relevant to facilitating user access, control, and/or configuration of the media playback system 100.

In examples described below, one or more of the various playback devices 102 may be configured as portable playback devices, while others may be configured as stationary playback devices. For example, certain playback devices 102, such as the headphones 1020 (FIG. 1B) or the playback device 102c on the patio 101i, for example, may include an internal power source (e.g., a rechargeable battery) that allows the playback device to operate without being physically connected to a mains electrical outlet or the like. In this regard, such a playback device may be referred to herein as a “portable playback device.” On the other hand, playback devices that are configured to rely on power from a mains electrical outlet or the like (such as the playback device 102d, for example) may be referred to herein as “stationary playback devices,” although such devices may in fact be moved around a home or other environment. In practice, a person might often take a portable playback device to and from a home or other environment in which one or more stationary playback devices remain.

The various playback and network microphone devices 102 and 103 of the MPS 100 may each be associated with a unique name, which may be assigned to the respective devices by a user, such as during setup of one or more of these devices. For example, some playback devices may be assigned names according to a zone or room in which the playback devices are located. Further, certain playback devices may have functionally descriptive names. For example, the playback devices 102a and 102b are assigned the names “Right” and “Front,” respectively, because these two devices are configured to provide specific audio channels during media playback in the zone of the Den 101d (FIG. 1A). Other naming conventions are possible.

With reference still to FIG. 1B, the various playback, network microphone, and controller devices 102-104 and/or other network devices of the MPS 100 may be coupled to one another via point-to-point connections and/or over other connections, which may be wired and/or wireless, via a LAN 111 including a network router 109. For example, the playback device 102j in the Den 101d (FIG. 1A), which may be designated as the “Left” device, may have a point-to-point connection with the playback device 102a, which is also in the Den 101d and may be designated as the “Right” device. In a related example, the Left playback device 102j may communicate with other network devices, such as the playback device 102b, which may be designated as the “Front” device, via a point-to-point connection and/or other connections via the LAN 111.

As further shown in FIG. 1B, the MPS 100 may be coupled to one or more remote computing devices 106 via a wide area network (“WAN”) 107. In some examples, each remote computing device 106 may take the form of one or more cloud servers. The remote computing devices 106 may be configured to interact with computing devices in the environment 101 in various ways. For example, the remote computing devices 106 may be configured to facilitate streaming and/or controlling playback of media content, such as audio, in the environment 101.

In some implementations, the various playback devices, NMDs, and/or controller devices 102-104 may be communicatively coupled to at least one remote computing device associated with a voice activated service (“VAS”) and at least one remote computing device associated with a media content service (“MCS”). For instance, in the illustrated example of FIG. 1B, remote computing devices 106a are associated with a VAS 190 and remote computing devices 106b are associated with an MCS 192. Although only a single VAS 190 and a single MCS 192 are shown in the example of FIG. 1B for purposes of clarity, the MPS 100 may be coupled to multiple, different VASes and/or MCSes. In some implementations, VASes may be operated by one or more of AMAZON, GOOGLE, APPLE, MICROSOFT, SONOS, or other voice assistant providers. In some implementations, MCSes may be operated by one or more of SPOTIFY, PANDORA, AMAZON MUSIC, or other media content services.

As further shown in FIG. 1B, the remote computing devices 106 further include remote computing device 106c configured to perform certain operations, such as remotely facilitating media playback functions, managing device and system status information, directing communications between the devices of the MPS 100 and one or multiple VASes and/or MCSes, among other operations. In one example, the remote computing devices 106c provide cloud servers for one or more SONOS Wireless Home Sound Systems.

As discussed above, an NMD may detect and process sound from its environment, such as sound that includes background noise mixed with speech spoken by a person in the NMD's vicinity. For example, as sounds are detected by the NMD in the environment, the NMD may process the detected sound to determine if the sound includes speech that contains voice input intended for the NMD and ultimately a particular VAS. For example, the NMD may identify whether speech includes a wake word associated with a particular VAS.

In the illustrated example of FIG. 1B, the NMDs 103 are configured to interact with the VAS 190 over a network via the LAN 111 and the router 109. Interactions with the VAS 190 may be initiated, for example, when an NMD identifies in the detected sound a potential wake word. The identification causes a wake-word event, which in turn causes the NMD to begin transmitting detected-sound data to the VAS 190. In some implementations, the various local network devices 102-105 (FIG. 1A) and/or remote computing devices 106c of the MPS 100 may exchange various feedback, information, instructions, and/or related data with the remote computing devices associated with the selected VAS. Such exchanges may be related to or independent of transmitted messages containing voice inputs. In some examples, the remote computing device(s) and the media playback system 100 may exchange data via communication paths as described herein and/or using a metadata exchange channel as described in U.S. Pat. No. 10,499,146 filed Feb. 21, 2017, and titled “Voice Control of a Media Playback System,” which is herein incorporated by reference in its entirety.

Upon receiving the stream of sound data, the VAS 190 determines if there is voice input in the streamed data from the NMD, and if so the VAS 190 will also determine an underlying intent in the voice input. The VAS 190 may next transmit a response back to the MPS 100, which can include transmitting the response directly to the NMD that caused the wake-word event. The response is typically based on the intent that the VAS 190 determined was present in the voice input. As an example, in response to the VAS 190 receiving a voice input with an utterance to “Play Hey Jude by The Beatles,” the VAS 190 may determine that the underlying intent of the voice input is to initiate playback and further determine that intent of the voice input is to play the particular song “Hey Jude.” After these determinations, the VAS 190 may transmit a command to a particular MCS 192 to retrieve content (i.e., the song “Hey Jude”), and that MCS 192, in turn, provides (e.g., streams) this content directly to the MPS 100 or indirectly via the VAS 190. In some implementations, the VAS 190 may transmit to the MPS 100 a command that causes the MPS 100 itself to retrieve the content from the MCS 192.

In certain implementations, NMDs may facilitate arbitration amongst one another when voice input is identified in speech detected by two or more NMDs located within proximity of one another. For example, the NMD-equipped playback device 102d in the environment 101 (FIG. 1A) is in relatively close proximity to the NMD-equipped Living Room playback device 102m, and both devices 102d and 102m may at least sometimes detect the same sound. In such cases, this may require arbitration as to which device is ultimately responsible for providing detected-sound data to the remote VAS. Examples of arbitrating between NMDs may be found, for example, in U.S. Pat. No. 10,499,146 referenced above.

In certain implementations, an NMD may be assigned to, or otherwise associated with, a designated or default playback device that may not include an NMD. For example, the Island NMD 103f in the Kitchen 101h (FIG. 1A) may be assigned to the Dining Room playback device 1021, which is in relatively close proximity to the Island NMD 103f. In practice, an NMD may direct an assigned playback device to play audio in response to a remote VAS receiving a voice input from the NMD to play the audio, which the NMD might have sent to the VAS in response to a user speaking a command to play a certain song, album, playlist, etc. Additional details regarding assigning NMDs and playback devices as designated or default devices may be found, for example, in U.S. Pat. No. 10,499,146 referenced above.

Further aspects relating to the different components of the example MPS 100 and how the different components may interact to provide a user with a media experience may be found in the following sections. While discussions herein may generally refer to the example MPS 100, technologies described herein are not limited to applications within, among other things, the home environment described above. For instance, the technologies described herein may be useful in other home environment configurations comprising more or fewer of any of the playback, network microphone, and/or controller devices 102-104. For example, the technologies herein may be utilized within an environment having a single playback device 102 and/or a single NMD 103. In some examples of such cases, the LAN 111 (FIG. 1B) may be eliminated and the single playback device 102 and/or the single NMD 103 may communicate directly with the remote computing devices 106 a-d. In some examples, a telecommunication network (e.g., an LTE network, a 5G network, etc.) may communicate with the various playback, network microphone, and/or controller devices 102-104 independent of a LAN.

a. Example Playback & Network Microphone Devices

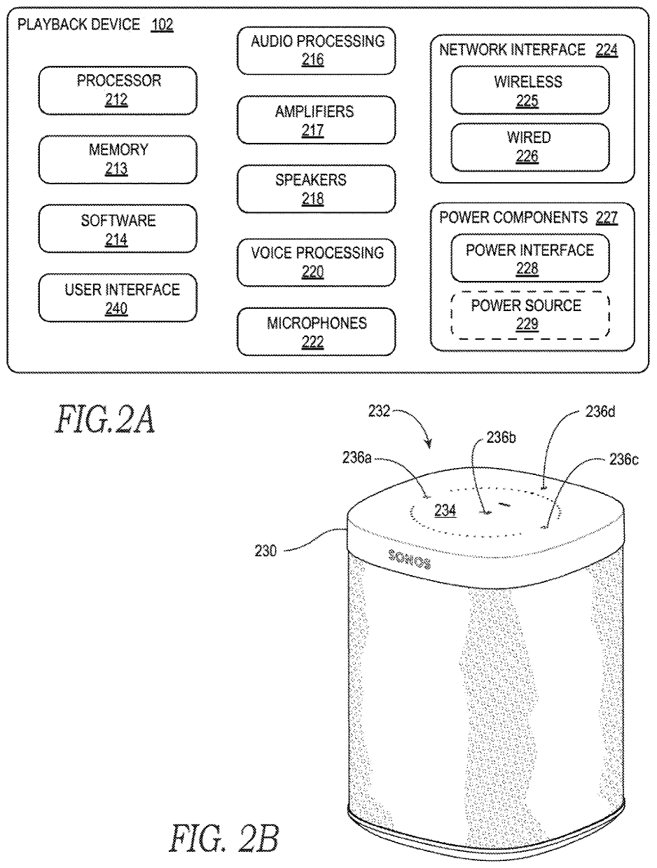

FIG. 2A is a functional block diagram illustrating certain aspects of one of the playback devices 102 of the MPS 100 of FIGS. 1A and 1B. As shown, the playback device 102 includes various components, each of which is discussed in further detail below, and the various components of the playback device 102 may be operably coupled to one another via a system bus, communication network, or some other connection mechanism. In the illustrated example of FIG. 2A, the playback device 102 may be referred to as an “NMD-equipped” playback device because it includes components that support the functionality of an NMD, such as one of the NMDs 103 shown in FIG. 1A.

As shown, the playback device 102 includes at least one processor 212, which may be a clock-driven computing component configured to process input data according to instructions stored in memory 213. The memory 213 may be a tangible, non-transitory, computer-readable medium configured to store instructions that are executable by the processor 212. For example, the memory 213 may be data storage that can be loaded with software code 214 that is executable by the processor 212 to achieve certain functions.

In one example, these functions may involve the playback device 102 retrieving audio data from an audio source, which may be another playback device. In another example, the functions may involve the playback device 102 sending audio data, detected-sound data (e.g., corresponding to a voice input), and/or other information to another device on a network via at least one network interface 224. In yet another example, the functions may involve the playback device 102 causing one or more other playback devices to synchronously playback audio with the playback device 102. In yet a further example, the functions may involve the playback device 102 facilitating being paired or otherwise bonded with one or more other playback devices to create a multi-channel audio environment. Numerous other example functions are possible, some of which are discussed below.

As just mentioned, certain functions may involve the playback device 102 synchronizing playback of audio content with one or more other playback devices. During synchronous playback, a listener may not perceive time-delay differences between playback of the audio content by the synchronized playback devices. U.S. Pat. No. 8,234,395 filed on Apr. 4, 2004, and titled “System and method for synchronizing operations among a plurality of independently clocked digital data processing devices,” which is hereby incorporated by reference in its entirety, provides in more detail some examples for audio playback synchronization among playback devices.

To facilitate audio playback, the playback device 102 includes audio processing components 216 that are generally configured to process audio prior to the playback device 102 rendering the audio. In this respect, the audio processing components 216 may include one or more digital-to-analog converters (“DAC”), one or more audio preprocessing components, one or more audio enhancement components, one or more digital signal processors (“DSPs”), and so on. In some implementations, one or more of the audio processing components 216 may be a subcomponent of the processor 212. In operation, the audio processing components 216 receive analog and/or digital audio and process and/or otherwise intentionally alter the audio to produce audio signals for playback.

The produced audio signals may then be provided to one or more audio amplifiers 217 for amplification and playback through one or more speakers 218 operably coupled to the amplifiers 217. The audio amplifiers 217 may include components configured to amplify audio signals to a level for driving one or more of the speakers 218.

Each of the speakers 218 may include an individual transducer (e.g., a “driver”) or the speakers 218 may include a complete speaker system involving an enclosure with one or more drivers. A particular driver of a speaker 218 may include, for example, a subwoofer (e.g., for low frequencies, such as audible frequencies below about 500 Hz), a mid-range driver (e.g., for middle frequencies, such as audible frequencies between about 500 Hz and about 2 kHz), and/or a tweeter (e.g., for high frequencies, such as audible frequencies above 2 kHz). In some cases, a transducer may be driven by an individual corresponding audio amplifier of the audio amplifiers 217. In some implementations, a playback device may not include the speakers 218, but instead may include a speaker interface for connecting the playback device to external speakers. In certain examples, a playback device may include neither the speakers 218 nor the audio amplifiers 217, but instead may include an audio interface (not shown) for connecting the playback device to an external audio amplifier or audio-visual receiver.

In addition to producing audio signals for playback by the playback device 102, the audio processing components 216 may be configured to process audio to be sent to one or more other playback devices, via the network interface 224, for playback. In example scenarios, audio content to be processed and/or played back by the playback device 102 may be received from an external source, such as via an audio line-in interface (e.g., an auto-detecting 3.5 mm audio line-in connection) of the playback device 102 (not shown) or via the network interface 224, as described below.

As shown, the at least one network interface 224, may take the form of one or more wireless interfaces 225 and/or one or more wired interfaces 226. A wireless interface may provide network interface functions for the playback device 102 to wirelessly communicate with other devices (e.g., other playback device(s), NMD(s), and/or controller device(s)) in accordance with a communication protocol (e.g., any wireless standard including IEEE 802.11a, 802.11b, 802.11g, 802.11n, 802.11ac, 802.11ax, 802.15, 4G or 5G mobile communication standard, WI-FIWI-FI 4, 5, or 6 standards, and so on). The wireless interface(s) 225 may also enable the playback device 102 to communicate using technologies and protocols such as BLUETOOTH, ultrasound, acoustic signaling, and ultra-wideband radio, to name a few. A wired interface may provide network interface functions for the playback device 102 to communicate over a wired connection with other devices in accordance with a communication protocol (e.g., IEEE 802.3). While the network interface 224 shown in FIG. 2A includes both wired and wireless interfaces, the playback device 102 may in some implementations include only wireless interface(s) or only wired interface(s).

In general, the network interface 224 facilitates data flow between the playback device 102 and one or more other devices on a data network. For instance, the playback device 102 may be configured to receive audio content over the data network from one or more other playback devices, network devices within a LAN, and/or audio content sources over a WAN, such as the Internet. In one example, the audio content and other signals transmitted and received by the playback device 102 may be transmitted in the form of digital packet data comprising an Internet Protocol (IP)-based source address and IP-based destination addresses. In such a case, the network interface 224 may be configured to parse the digital packet data such that the data destined for the playback device 102 is properly received and processed by the playback device 102.

As shown in FIG. 2A, the playback device 102 also includes voice processing components 220 that are operably coupled to one or more microphones 222. The microphones 222 are configured to detect sound (i.e., acoustic waves) in the environment of the playback device 102, which is then provided to the voice processing components 220. More specifically, each microphone 222 is configured to detect sound and convert the sound into a digital or analog signal representative of the detected sound, which can then cause the voice processing component 220 to perform various functions based on the detected sound, as described in greater detail below. In one implementation, the microphones 222 are arranged as an array of microphones (e.g., an array of six microphones). In some implementations, the playback device 102 includes more than six microphones (e.g., eight microphones or twelve microphones) or fewer than six microphones (e.g., four microphones, two microphones, or a single microphone).

In operation, the voice-processing components 220 are generally configured to detect and process sound received via the microphones 222, identify potential voice input in the detected sound, and extract detected-sound data to enable a VAS, such as the VAS 190 (FIG. 1B), to process voice input identified in the detected-sound data. The voice processing components 220 may include one or more analog-to-digital converters, an acoustic echo canceller (“AEC”), a spatial processor (e.g., one or more multi-channel Wiener filters, one or more other filters, and/or one or more beam former components), one or more buffers (e.g., one or more circular buffers), one or more wake-word engines, one or more voice extractors, and/or one or more speech processing components (e.g., components configured to recognize a voice of a particular user or a particular set of users associated with a household), among other example voice processing components. In example implementations, the voice processing components 220 may include or otherwise take the form of one or more DSPs or one or more modules of a DSP. In this respect, certain voice processing components 220 may be configured with particular parameters (e.g., gain and/or spectral parameters) that may be modified or otherwise tuned to achieve particular functions. In some implementations, one or more of the voice processing components 220 may be a subcomponent of the processor 212.

In some implementations, the voice-processing components 220 may detect and store a user's voice profile, which may be associated with a user account of the MPS 100. For example, voice profiles may be stored as and/or compared to variables stored in a set of command information or data table. The voice profile may include aspects of the tone or frequency of a user's voice and/or other unique aspects of the user's voice, such as those described in U.S. Pat. No. 10,499,146 referenced above.

As further shown in FIG. 2A, the playback device 102 also includes power components 227. The power components 227 include at least an external power source interface 228, which may be coupled to a power source (not shown) via a power cable or the like that physically connects the playback device 102 to an electrical outlet or some other external power source. Other power components may include, for example, transformers, converters, and like components configured to format electrical power.

In some implementations, the power components 227 of the playback device 102 may additionally include an internal power source 229 (e.g., one or more batteries) configured to power the playback device 102 without a physical connection to an external power source. When equipped with the internal power source 229, the playback device 102 may operate independently of an external power source. In some such implementations, the external power source interface 228 may be configured to facilitate charging the internal power source 229. As discussed above, a playback device comprising an internal power source may be referred to herein as a “portable playback device.” On the other hand, a playback device that operates using an external power source may be referred to herein as a “stationary playback device,” although such a device may in fact be moved around a home or other environment.

The playback device 102 further includes a user interface 240 that may facilitate user interactions independent of or in conjunction with user interactions facilitated by one or more of the controller devices 104. In various examples, the user interface 240 includes one or more physical buttons and/or supports graphical interfaces provided on touch sensitive screen(s) and/or surface(s), among other possibilities, for a user to directly provide input. The user interface 240 may further include one or more of lights (e.g., LEDs) and speakers to provide visual and/or audio feedback to a user.

As an illustrative example, FIG. 2B shows an example housing 230 of the playback device 102 that includes a user interface in the form of a control area 232 at a top portion 234 of the housing 230. The control area 232 includes buttons 236a-c for controlling audio playback, volume level, and other functions. The control area 232 also includes a button 236d for toggling the microphones 222 to either an on state or an off state.

As further shown in FIG. 2B, the control area 232 is at least partially surrounded by apertures formed in the top portion 234 of the housing 230 through which the microphones 222 (not visible in FIG. 2B) receive sound from the environment of the playback device 102. The microphones 222 may be arranged in various positions along and/or within the top portion 234 or other areas of the housing 230 so as to detect sound from one or more directions relative to the playback device 102.

By way of illustration, Sonos, Inc. presently offers (or has offered) for sale certain playback devices that may implement certain of the examples disclosed herein, including a “PLAY:1,” “PLAY:3,” “PLAY:5,” “PLAYBAR,” “CONNECT:AMP,” “PLAYBASE,” “BEAM,” “CONNECT,” “AMP,” “PORT,” and “SUB.” Any other past, present, and/or future playback devices may additionally or alternatively be used to implement the playback devices of example aspects disclosed herein. Additionally, it should be understood that a playback device is not limited to the examples illustrated in FIG. 2A or 2B or to the Sonos product offerings. For example, a playback device may include, or otherwise take the form of, a wired or wireless headphone set, which may operate as a part of the media playback system 100 via a network interface or the like. In another example, a playback device may include or interact with a docking station for personal mobile media playback devices. In yet another example, a playback device may be integral to another device or component such as a television, an LP turntable, a lighting fixture, or some other device for indoor or outdoor use.

b. Example Playback Device Configurations

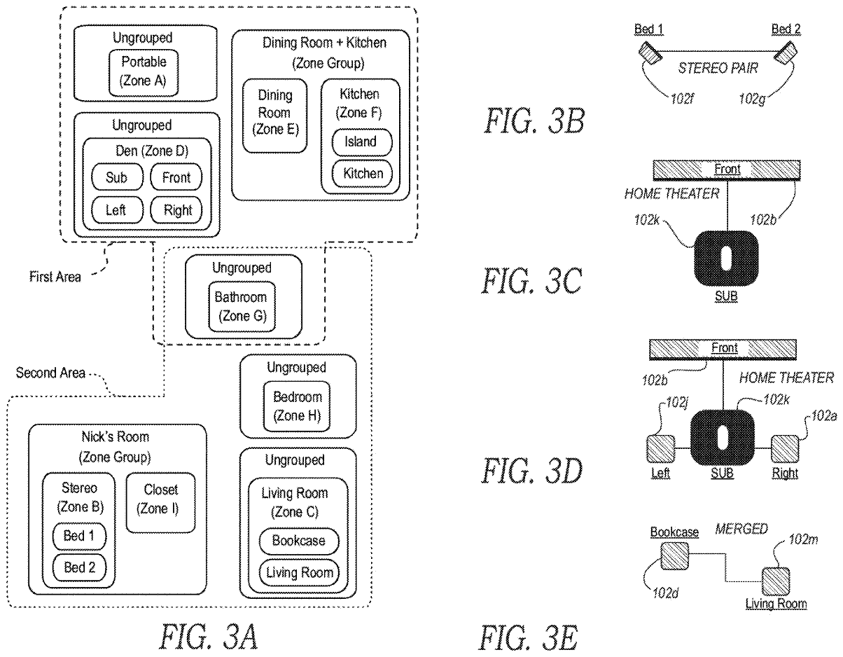

FIGS. 3A-3E show example configurations of playback devices. Referring first to FIG. 3A, in some example instances, a single playback device may belong to a zone. For example, the playback device 102c (FIG. 1A) on the Patio may belong to Zone A. In some implementations described below, multiple playback devices may be “bonded” to form a “bonded pair,” which together form a single zone. For example, the playback device 102f (FIG. 1A) named “Bed 1” in FIG. 3A may be bonded to the playback device 102g (FIG. 1A) named “Bed 2” in FIG. 3A to form Zone B. Bonded playback devices may have different playback responsibilities (e.g., channel responsibilities). In another implementation described below, multiple playback devices may be merged to form a single zone. For example, the playback device 102d named “Bookcase” may be merged with the playback device 102m named “Living Room” to form a single Zone C. The merged playback devices 102d and 102m may not be specifically assigned different playback responsibilities. That is, the merged playback devices 102d and 102m may, aside from playing audio content in synchrony, each play audio content as they would if they were not merged.

For purposes of control, each zone in the MPS 100 may be represented as a single user interface (“UI”) entity. For example, as displayed by the controller devices 104, Zone A may be provided as a single entity named “Portable,” Zone B may be provided as a single entity named “Stereo,” and Zone C may be provided as a single entity named “Living Room.”

In various examples, a zone may take on the name of one of the playback devices belonging to the zone. For example, Zone C may take on the name of the Living Room device 102m (as shown). In another example, Zone C may instead take on the name of the Bookcase device 102d. In a further example, Zone C may take on a name that is some combination of the Bookcase device 102d and Living Room device 102m. The name that is chosen may be selected by a user via inputs at a controller device 104. In some examples, a zone may be given a name that is different than the device(s) belonging to the zone. For example, Zone B in FIG. 3A is named “Stereo” but none of the devices in Zone B have this name. In one aspect, Zone B is a single UI entity representing a single device named “Stereo,” composed of constituent devices “Bed 1” and “Bed 2.” In one implementation, the Bed 1 device may be playback device 102f in the master bedroom 101h (FIG. 1A) and the Bed 2 device may be the playback device 102g also in the master bedroom 101h (FIG. 1A).

As noted above, playback devices that are bonded may have different playback responsibilities, such as playback responsibilities for certain audio channels. For example, as shown in FIG. 3B, the Bed 1 and Bed 2 devices 102f and 102g may be bonded so as to produce or enhance a stereo effect of audio content. In this example, the Bed 1 playback device 102f may be configured to play a left channel audio component, while the Bed 2 playback device 102g may be configured to play a right channel audio component. In some implementations, such stereo bonding may be referred to as “pairing.”

Additionally, playback devices that are configured to be bonded may have additional and/or different respective speaker drivers. As shown in FIG. 3C, the playback device 102b named “Front” may be bonded with the playback device 102k named “SUB.” The Front device 102b may render a range of mid to high frequencies, and the SUB device 102k may render low frequencies as, for example, a subwoofer. When unbonded, the Front device 102b may be configured to render a full range of frequencies. As another example, FIG. 3D shows the Front and SUB devices 102b and 102k further bonded with Right and Left playback devices 102a and 102j, respectively. In some implementations, the Right and Left devices 102a and 102j may form surround or “satellite” channels of a home theater system. The bonded playback devices 102a, 102b, 102j, and 102k may form a single Zone D (FIG. 3A).

In some implementations, playback devices may also be “merged.” In contrast to certain bonded playback devices, playback devices that are merged may not have assigned playback responsibilities, but may each render the full range of audio content that each respective playback device is capable of. Nevertheless, merged devices may be represented as a single UI entity (i.e., a zone, as discussed above). For instance, FIG. 3E shows the playback devices 102d and 102m in the Living Room merged, which would result in these devices being represented by the single UI entity of Zone C. In one example, the playback devices 102d and 102m may playback audio in synchrony, during which each outputs the full range of audio content that each respective playback device 102d and 102m is capable of rendering.

In some examples, a stand-alone NMD may be in a zone by itself. For example, the NMD 103h from FIG. 1A is named “Closet” and forms Zone I in FIG. 3A. An NMD may also be bonded or merged with another device so as to form a zone. For example, the NMD device 103f named “Island” may be bonded with the playback device 102i Kitchen, which together form Zone F, which is also named “Kitchen.” Additional details regarding assigning NMDs and playback devices as designated or default devices may be found, for example, in U.S. Pat. No. 10,499,146 referenced above. In some examples, a stand-alone NMD may not be assigned to a zone.

Zones of individual, bonded, and/or merged devices may be arranged to form a set of playback devices that playback audio in synchrony. Such a set of playback devices may be referred to as a “group,” “zone group,” “synchrony group,” or “playback group.” In response to inputs provided via a controller device 104, playback devices may be dynamically grouped and ungrouped to form new or different groups that synchronously play back audio content. For example, referring to FIG. 3A, Zone A may be grouped with Zone B to form a zone group that includes the playback devices of the two zones. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in U.S. Pat. No. 8,234,395 referenced above. Grouped and bonded devices are example types of associations between portable and stationary playback devices that may be caused in response to a trigger event, as discussed above and described in greater detail below.

In various implementations, the zones in an environment may be assigned a particular name, which may be the default name of a zone within a zone group or a combination of the names of the zones within a zone group, such as “Dining Room +Kitchen,” as shown in FIG. 3A. In some examples, a zone group may be given a unique name selected by a user, such as “Nick's Room,” as also shown in FIG. 3A. The name “Nick's Room” may be a name chosen by a user over a prior name for the zone group, such as the room name “Master Bedroom.”

Referring back to FIG. 2A, certain data may be stored in the memory 213 as one or more state variables that are periodically updated and used to describe the state of a playback zone, the playback device(s), and/or a zone group associated therewith. The memory 213 may also include the data associated with the state of the other devices of the media playback system 100, which may be shared from time to time among the devices so that one or more of the devices have the most recent data associated with the system.

In some examples, the memory 213 of the playback device 102 may store instances of various variable types associated with the states. Variable instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, in FIG. 1A, identifiers associated with the Patio may indicate that the Patio is the only playback device of a particular zone and not in a zone group. Identifiers associated with the Living Room may indicate that the Living Room is not grouped with other zones but includes bonded playback devices 102a, 102b, 102j, and 102k. Identifiers associated with the Dining Room may indicate that the Dining Room is part of Dining Room+Kitchen group and that devices 103f and 102i are bonded. Identifiers associated with the Kitchen may indicate the same or similar information by virtue of the Kitchen being part of the Dining Room+Kitchen zone group. Other example zone variables and identifiers are described below.

In yet another example, the MPS 100 may include variables or identifiers representing other associations of zones and zone groups, such as identifiers associated with Areas, as shown in FIG. 3A. An Area may involve a cluster of zone groups and/or zones not within a zone group. For instance, FIG. 3A shows a first area named “First Area” and a second area named “Second Area.” The First Area includes zones and zone groups of the Patio, Den, Dining Room, Kitchen, and Bathroom. The Second Area includes zones and zone groups of the Bathroom, Nick's Room, Bedroom, and Living Room. In one aspect, an Area may be used to invoke a cluster of zone groups and/or zones that share one or more zones and/or zone groups of another cluster. In this respect, such an Area differs from a zone group, which does not share a zone with another zone group. Further examples of techniques for implementing Areas may be found, for example, in U.S. Pat. No. 10,712,997 filed Aug. 21, 2017 and titled “Room Association Based on Name,” and U.S. Pat. No. 8,483,853 filed Sep. 11, 2007, and titled “Controlling and manipulating groupings in a multi-zone media system.” Each of these applications is incorporated herein by reference in its entirety. In some examples, the MPS 100 may not implement Areas, in which case the system may not store variables associated with Areas.

The memory 213 may be further configured to store other data. Such data may pertain to audio sources accessible by the playback device 102 or a playback queue that the playback device (or some other playback device(s)) may be associated with. In examples described below, the memory 213 is configured to store a set of command data for selecting a particular VAS when processing voice inputs.

During operation, one or more playback zones in the environment of FIG. 1A may each be playing different audio content. For instance, the user may be grilling in the Patio zone and listening to hip hop music being played by the playback device 102c, while another user may be preparing food in the Kitchen zone and listening to classical music being played by the playback device 102i. In another example, a playback zone may play the same audio content in synchrony with another playback zone. For instance, the user may be in the Office zone where the playback device 102n is playing the same hip-hop music that is being played by playback device 102c in the Patio zone. In such a case, playback devices 102c and 102n may be playing the hip-hop in synchrony such that the user may seamlessly (or at least substantially seamlessly) enjoy the audio content that is being played out-loud while moving between different playback zones. Synchronization among playback zones may be achieved in a manner similar to that of synchronization among playback devices, as described in U.S. Pat. No. 8,234,395 referenced above.

As suggested above, the zone configurations of the MPS 100 may be dynamically modified. As such, the MPS 100 may support numerous configurations. For example, if a user physically moves one or more playback devices to or from a zone, the MPS 100 may be reconfigured to accommodate the change(s). For instance, if the user physically moves the playback device 102c from the Patio zone to the Office zone, the Office zone may now include both the playback devices 102c and 102n. In some cases, the user may pair or group the moved playback device 102c with the Office zone and/or rename the players in the Office zone using, for example, one of the controller devices 104 and/or voice input. In other instances, the MPS may automatically reconfigure one or more playback devices based on tracking the movement of at least one portable playback device and acquiring localization information for the at least one portable playback devices, as discussed in more detail below. As another example, if one or more playback devices 102 are moved to a particular space in the home environment that is not already a playback zone, the moved playback device(s) may be renamed or associated with a playback zone for the particular space.

Further, different playback zones of the MPS 100 may be dynamically combined into zone groups or split up into individual playback zones. For example, the Dining Room zone and the Kitchen zone may be combined into a zone group for a dinner party such that playback devices 102i and 1021 may render audio content in synchrony. As another example, bonded playback devices in the Den zone may be split into (i) a television zone and (ii) a separate listening zone. The television zone may include the Front playback device 102b. The listening zone may include the Right, Left, and SUB playback devices 102a, 102j, and 102k, which may be grouped, paired, or merged, as described above. Splitting the Den zone in such a manner may allow one user to listen to music in the listening zone in one area of the living room space, and another user to watch the television in another area of the living room space. In a related example, a user may utilize either of the NMD 103a or 103b (FIG. 1B) to control the Den zone before it is separated into the television zone and the listening zone. Once separated, the listening zone may be controlled, for example, by a user in the vicinity of the NMD 103a, and the television zone may be controlled, for example, by a user in the vicinity of the NMD 103b. As described above, however, any of the NMDs 103 may be configured to control the various playback and other devices of the MPS 100.

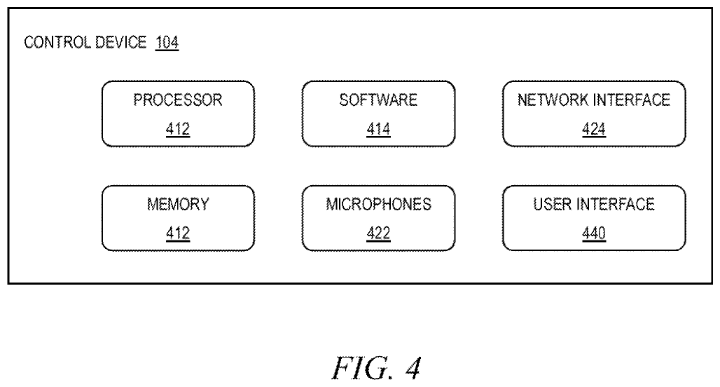

c. Example Controller Devices
FIG. 4A is a functional block diagram illustrating certain aspects of a selected one of the controller devices 104 of the MPS 100 of FIG. 1A. Such controller devices may also be referred to herein as a “control device” or “controller.” The controller device shown in FIG. 4A may include components that are generally similar to certain components of the network devices described above, such as a processor 412, memory 413 storing program software 414, at least one network interface 424, and one or more microphones 422. In one example, a controller device may be a dedicated controller for the MPS 100. In another example, a controller device may be a network device on which media playback system controller application software may be installed, such as for example, an iPhone™, iPad™ or any other smart phone, tablet, or network device (e.g., a networked computer such as a PC or Mac™).

The memory 413 of the controller device 104 may be configured to store controller application software and other data associated with the MPS 100 and/or a user of the system 100. The memory 413 may be loaded with instructions in software 414 that are executable by the processor 412 to achieve certain functions, such as facilitating user access, control, and/or configuration of the MPS 100. The controller device 104 is configured to communicate with other network devices via the network interface 424, which may take the form of a wireless interface, as described above.

In one example, system information (e.g., such as a state variable) may be communicated between the controller device 104 and other devices via the network interface 424. For instance, the controller device 104 may receive playback zone and zone group configurations in the MPS 100 from a playback device, an NMD, or another network device. Likewise, the controller device 104 may transmit such system information to a playback device or another network device via the network interface 424. In some cases, the other network device may be another controller device.

The controller device 104 may also communicate playback device control commands, such as volume control and audio playback control, to a playback device via the network interface 424. As suggested above, changes to configurations of the MPS 100 may also be performed by a user using the controller device 104. The configuration changes may include adding/removing one or more playback devices to/from a zone, adding/removing one or more zones to/from a zone group, forming a bonded or merged player, separating one or more playback devices from a bonded or merged player, among others. Accordingly, the controller device includes a user interface 440 that is generally configured to facilitate user access and control of the MPS 100. The user interface 440 may include a touch-screen display or other physical interface configured to provide various graphical controller interfaces to allow a user to interact with the MPS 100. For example, the user interface 440 may allow the user to instruct one or more playback devices 102 to play music (including actions such as pause, skip, fast forward, stop, etc.), view, create, and/or modify playback zones or playback device groupings within the MPS 100, view information about the music being played (e.g., song title, artist, etc.), and/or create, modify, and view playlists, among various other activities. Examples of controller devices 104 are described in more detail in U.S. Pat. No. 10,499,146, for example.

d. Example Audio Content Sources

The audio sources in the sources region 448 may be audio content sources from which audio content may be retrieved and played by the selected playback zone or zone group. One or more playback devices in a zone or zone group may be configured to retrieve for playback audio content (e.g., according to a corresponding URI or URL for the audio content) from a variety of available audio content sources. In one example, audio content may be retrieved by a playback device directly from a corresponding audio content source (e.g., via a line-in connection). In another example, audio content may be provided to a playback device over a network via one or more other playback devices or network devices. As described in greater detail below, in some examples, audio content may be provided by one or more media content services.

Example audio content sources may include a memory of one or more playback devices in a media playback system such as the MPS 100 of FIG. 1A, local music libraries on one or more network devices (e.g., a controller device, a network-enabled personal computer, or a networked-attached storage (“NAS”)), streaming audio services providing audio content via the Internet (e.g., cloud-based music services), or audio sources connected to the media playback system via a line-in input connection on a playback device or network device, among other possibilities.

e. Example Network Microphone Devices

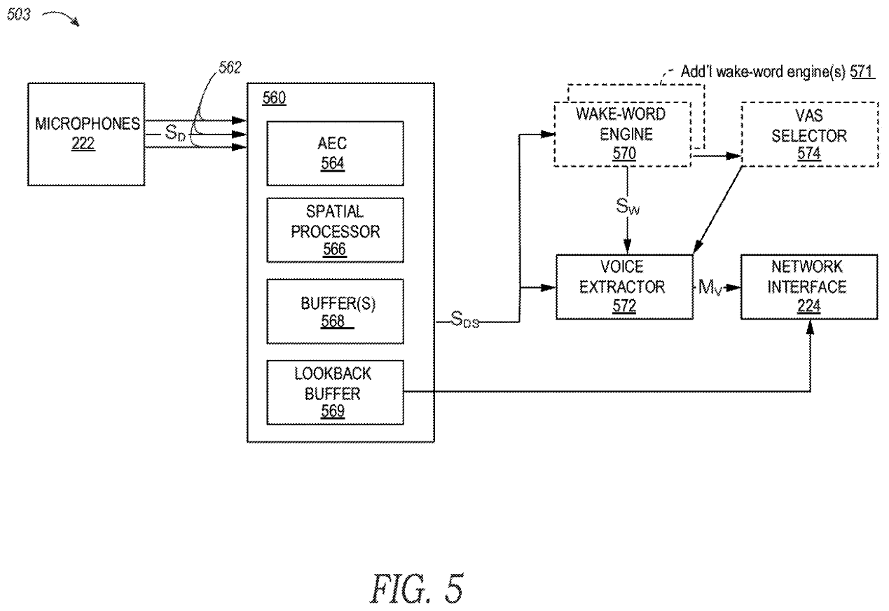

FIG. 5 is a functional block diagram showing an NMD 503 configured in accordance with aspects of the disclosure. The NMD 503 includes voice capture components (“VCC”, or collectively “voice processor 560”), and optionally also includes a wake-word engine 570, and at least one voice extractor 572, each of which is operably coupled to the voice processor 560. The NMD 503 further includes the microphones 222 and the at least one network interface 224 described above and may also include other components, such as audio amplifiers, interface, etc., which are not shown in FIG. 5 for purposes of clarity.

The microphones 222 of the NMD 503 are configured to provide detected sound, SD, from the environment of the NMD 503 to the voice processor 560. The detected sound SD may take the form of one or more analog or digital signals. In example implementations, the detected sound SD may be composed of a plurality of signals associated with respective channels 562 that are fed to the voice processor 560.

Each channel 562 may correspond to a particular microphone 222. For example, an NMD having six microphones may have six corresponding channels. Each channel of the detected sound SD may bear certain similarities to the other channels but may differ in certain regards, which may be due to the position of the given channel's corresponding microphone relative to the microphones of other channels. For example, one or more of the channels of the detected sound SD may have a greater signal to noise ratio (“SNR”) of speech to background noise than other channels.

As further shown in FIG. 5, the voice processor 560 includes an AEC 564, a spatial processor 566, and one or more buffers 568. In operation, the AEC 564 receives the detected sound SD and filters or otherwise processes the sound to suppress echoes and/or to otherwise improve the quality of the detected sound SD. That processed sound may then be passed to the spatial processor 566.

The spatial processor 566 is typically configured to analyze the detected sound SD and identify certain characteristics, such as a sound's amplitude (e.g., decibel level), frequency spectrum, directionality, etc. In one respect, the spatial processor 566 may help filter or suppress ambient noise in the detected sound SD from potential user speech based on similarities and differences in the constituent channels 562 of the detected sound SD, as discussed above. As one possibility, the spatial processor 566 may monitor metrics that distinguish speech from other sounds. Such metrics can include, for example, energy within the speech band relative to background noise and entropy within the speech band-a measure of spectral structure-which is typically lower in speech than in most common background noise. In some implementations, the spatial processor 566 may be configured to determine a speech presence probability, examples of such functionality are disclosed in U.S. Patent No. 10,847,178, filed May 18, 2018, titled “Linear Filtering for Noise-Suppressed Speech Detection,” and U.S. Pat. No. 10,692,518, filed Sep. 29, 2018, and titled “Linear Filtering for Noise-Suppressed Speech Detection via Multiple Network Microphone Devices,” each of which is incorporated herein by reference in its entirety.

If the NMD 503 includes a wake-word engine 570, the wake-word engine 570 can be configured to monitor and analyze received audio to determine if any wake words are present in the audio. The wake-word engine 570 may analyze the received audio using a wake word detection algorithm. If the wake-word engine 570 detects a wake word, a network microphone device may process voice input contained in the received audio. In some examples, the wake-word engine 570 runs multiple wake word detection algorithms on the received audio simultaneously (or substantially simultaneously). As noted above, different voice services (e.g. AMAZON's ALEXA, APPLE's SIRI, MICROSOFT's CORTANA, GOOGLE'S Assistant, etc.) each use a different wake word for invoking their respective voice service. To support multiple services, the wake-word engine 570 may run the received audio through the wake word detection algorithm for each supported voice service in parallel. In such examples, the network microphone device 103 may include VAS selector components 574 configured to pass voice input to the appropriate voice assistant service.

In operation, the one or more buffers 568—one or more of which may be part of or separate from the memory 213 (FIG. 2A)—capture data corresponding to the detected sound SD. More specifically, the one or more buffers 568 capture detected-sound data that was processed by the upstream AEC 564 and spatial processor 566.

In general, the detected-sound data form a digital representation (i.e., sound-data stream), SDs, of the sound detected by the microphones 222. In practice, the sound-data stream SDs may take a variety of forms. As one possibility, the sound-data stream Sos may be composed of frames, each of which may include one or more sound samples. The frames may be streamed (i.e., read out) from the one or more buffers 568 for further processing by downstream components, such as the wake-word engine 570 and the voice extractor 572 of the NMD 503.

In some implementations, at least one buffer 568 captures detected-sound data utilizing a sliding window approach in which a given amount (i.e., a given window) of the most recently captured detected-sound data is retained in the at least one buffer 568 while older detected-sound data are overwritten when they fall outside of the window. For example, at least one buffer 568 may temporarily retain 20 frames of a sound specimen at given time, discard the oldest frame after an expiration time, and then capture a new frame, which is added to the 19 prior frames of the sound specimen.

In practice, when the sound-data stream Sos is composed of frames, the frames may take a variety of forms having a variety of characteristics. As one possibility, the frames may take the form of audio frames that have a certain resolution (e.g., 16 bits of resolution), which may be based on a sampling rate (e.g., 44,100 Hz). Additionally, or alternatively, the frames may include information corresponding to a given sound specimen that the frames define, such as metadata that indicates frequency response, power input level, signal-to-noise ratio, microphone channel identification, and/or other information of the given sound specimen, among other examples. Thus, in some examples, a frame may include a portion of sound (e.g., one or more samples of a given sound specimen) and metadata regarding the portion of sound. In other examples, a frame may only include a portion of sound (e.g., one or more samples of a given sound specimen) or metadata regarding a portion of sound.

The voice processor 560 also includes at least one lookback buffer 569, which may be part of or separate from the memory 213 (FIG. 2A). In operation, the lookback buffer 569 can store sound metadata that is processed based on the detected-sound data SD received from the microphones 222. As noted above, the microphones 222 can include a plurality of microphones arranged in an array. The sound metadata can include, for example: (1) frequency response data for individual microphones of the array, (2) an echo return loss enhancement measure (i.e., a measure of the effectiveness of the acoustic echo canceller (AEC) for each microphone), (3) a voice direction measure; (4) arbitration statistics (e.g., signal and noise estimates for the spatial processing streams associated with different microphones); and/or (5) speech spectral data (i.e., frequency response evaluated on processed audio output after acoustic echo cancellation and spatial processing have been performed). Other sound metadata may also be used to identify and/or classify noise in the detected-sound data SD. In at least some examples, the sound metadata may be transmitted separately from the sound-data stream SDs, as reflected in the arrow extending from the lookback buffer 569 to the network interface 224. For example, the sound metadata may be transmitted from the lookback buffer 569 to one or more remote computing devices separate from the VAS which receives the sound-data stream SDs. In some examples, for instance, the metadata can be transmitted to a remote service provider for analysis to construct or modify a noise classifier.

Components of the NMD 503 downstream of the voice processor 560 may process the sound-data stream SDs. For instance, the wake-word engine 570 can be configured to apply one or more identification algorithms to the sound-data stream SDs (e.g., streamed sound frames) to spot potential wake words in the detected-sound SD. When the wake-word engine 570 spots a potential wake word, the wake-word engine 570 can provide an indication of a “wake-word event” (also referred to as a “wake-word trigger”) to the voice extractor 572 in the form of signal Sw.

In response to the wake-word event (e.g., in response to a signal Sw from the wake-word engine 570 indicating the wake-word event), the voice extractor 572 is configured to receive and format (e.g., packetize) the sound-data stream SDs. For instance, the voice extractor 572 packetizes the frames of the sound-data stream SDs into messages. The voice extractor 572 transmits or streams these messages, Mv, that may contain voice input in real time or near real time to a remote VAS, such as the VAS 190 (FIG. 1B), via the network interface 224.

With continued reference to FIG. 5, in multi-VAS implementations, the NMD 503 may include a VAS selector 574 (shown in dashed lines) that is generally configured to direct the voice extractor's extraction and transmission of the sound-data stream SDs to the appropriate VAS when a given wake-word is identified by a particular wake-word engine, such as the first wake-word engine 570a, the second wake-word engine 570b, or the additional wake-word engine 571. In such implementations, the NMD 503 may include multiple, different wake-word engines and/or voice extractors, each supported by a particular VAS.

III. Positioning System Examples As discussed above, a plurality of network devices, such as playback devices 102 and/or NMDs 103, can be distributed within an environment 101, such as a user's home, or a commercial space (e.g., a restaurant, retail store, mall, hotel, etc.) Some of the devices may be in relatively fixed locations within the environment 101, whereas others may be portable and be frequently moved from one location to another. As the capabilities of these devices expand, it is becoming increasingly desirable to locate and interact with the devices within the environment 101. According to certain aspects, a positioning system can be implemented to determine relative positioning of devices within the environment 101 and optionally to control or modify behavior of one or more devices based on the relative positions. Positioning or localization information can be acquired through various techniques, optionally using sensors in some instances, examples of which are discussed below. In certain examples, one or more devices in the MPS 100, such as one or more playback devices 102, NMDs 103, or controller devices 104 may host a localization application that may implement operations (also referred to herein as functional capabilities or functionalities) that process localization information to enhance user experiences with the MPS 100. Examples of such operations include sophisticated acoustic manipulation (e.g., functional capabilities directed to psychoacoustic effects during audio playback) and autonomous device configuration/reconfiguration (e.g., functional capabilities directed to detection and configuration of new devices or devices that have moved or otherwise been changed in some way), among others. The requirements that these operations place on localization information vary, with some operations requiring low latency, high precision localization information and other operations being able to operate using high latency, low precision localization information.

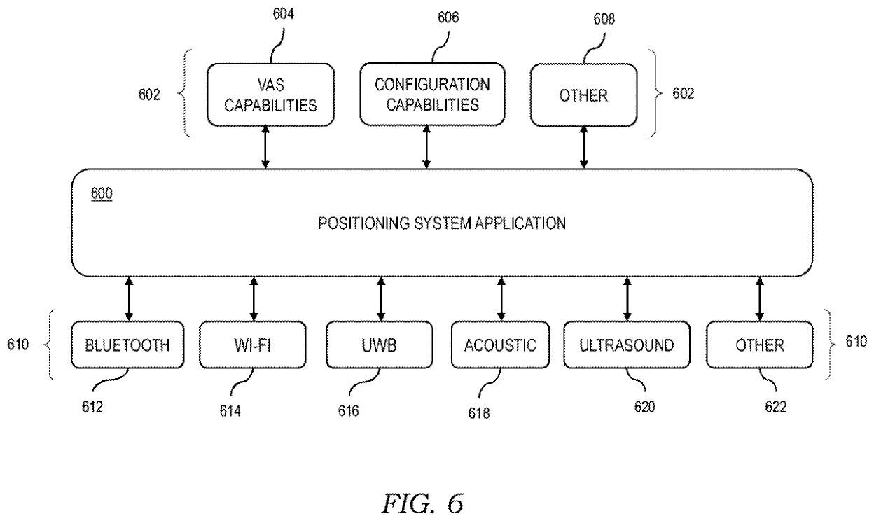

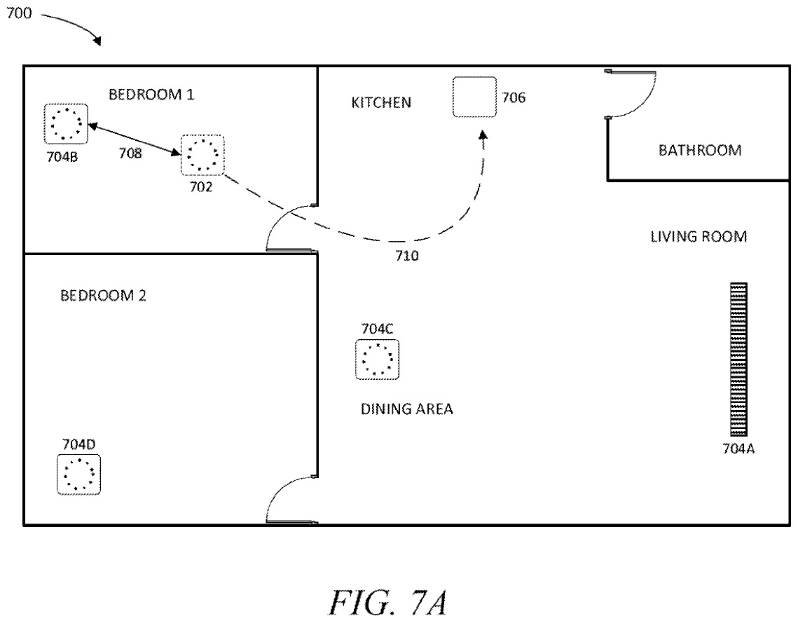

According to certain examples, a positioning system can be implemented in the MPS 100 using a variety of different devices to generate the localization information utilized by certain application functionalities. However, the number, arrangement, and configuration of these devices can vary between examples. Additionally or alternatively, the communications technology and/or sensors employed by the devices can vary. Given the number of variables in play within any particular MPS and the concomitant inefficiencies that this variability imposes on MPS application operation development and maintenance, some examples disclosed herein utilize one or more playback devices 102, NMDs 103, or controller devices 104 to implement a positioning system using a common positioning application programming interface (API) that decouples the positioning/localization information from specific devices or underlying enabling technologies, as illustrated conceptually in FIG. 6.

Referring to FIG. 6, any one or more playback devices 102, NMDs 103, or controller devices 104 in the MPS 100 (“MPS devices”) can host a positioning system application 600. In certain implementations, one or more remote computing devices can facilitate hosting the application. The positioning system application 600 implements an application programming interface (API) that exposes positioning/localization information, and metadata pertinent thereto, to MPS application functionalities 602. The MPS functionalities 602 may include a wide variety of functional capabilties relating to various user experiences and aspects of the operation of the MPS 100. For example, the MPS functionalities 602 may include one or more VAS capabilties 604, such as voice disambiguation features and arbitration between different NMDs receiving the same voice inputs, for example. The MPS functionalities 602 may also include one or more MPS and/or device configuration capabilities 606, such as automatic home theatre configuration or reconfiguration, dynamically accommodating portable playback devices in home theatre environments, dynamic room assignment for portable playback devices or their associated docks, and contextual orientation of controller devices 104, to name a few. The MPS functionalities 602 may further include one or more other capabilities 608 that use positioning/localization information. To support these and other MPS functionalities 602, positioning/localization information may be used to determine various pieces of information related to the locations of MPS devices within the environment 101. For example, the positioning/localization information may be used by some MPS functionalities 602 to keep track of which playback devices 102 or NMDs 103 are in a given room or space (e.g., which playback devices are in the living room 101f, in which room is playback device 102d, or which playback devices 102 are closest to the controller device 104). The positioning/localization information may further be used to determine the distance and/or orientation between playback devices 102 (with varying levels of precision), or to determine the acoustic space around NMDs 103 or NMD-equipped playback devices 102 (e.g., which playback devices 102 can be heard from NMD 103a). Thus, the positioning/localization information may be used to determine information about the topology of the MPS 100 within the environment 101, which information may then be used to automatically and dynamically create or modify user experiences with the MPS 100 and support the MPS functionalities 602.

In some examples, the positioning/localization information is obtained through the exchange of wireless signals among network devices (point-to-point signaling) within the MPS 100. For example, in response to a signaling trigger, some or all of the MPS devices emit one or more wireless signals and “listen” for the wireless signals emitted by other MPS devices. Each of the wireless signal can include a device identifier that identifies the network device from which the respective wireless signal was emitted. Based on detecting the various wireless signals, one or more of the MPS devices can determine certain positioning/localization information. For example, one or more MPS devices may establish a reference pattern that describes distances and directions between MPS devices based on signal strength measurements. In another example, an MPS device may detect the presence of another MPS device based on detecting the wireless signal(s) emitted by the other MPS device. In some examples, the signaling trigger is based on a schedule. For example, some or all of the MPS devices can be configured to periodically emit and/or listen for wireless signals. In another example, a coordinating MPS device may broadcast an instruction to other MPS devices directing the other MPS devices to emit and/or listen for wireless signals. In another example, a portable playback device that detects its movement (e.g., through an on-board sensor, such as a inertial measurement unit, or through connection to or disconnection from its docking station, or via some other mechanism)may broadcast a request for other MPS devices to emit the wireless signals, such that the portable playback device can determine its new position relative to one or more of the other MPS devices by detecting the wireless signals emitted by the one or more other MPS devices. Various other examples are possible.

The positioning/localization information and metadata exposed by the positioning system application 600 may vary depending on the underlying communications technologies and/or sensor capabilities 610 within the MPS devices that are used to acquire the information and/or the needs of the particular MPS functionality 602. For example, certain MPS devices may be equipped with one or more network interfaces 224 that support any one or more of the following communications capabilities: BLUETOOTH 612, WI-FIWI-FI 614 or ultra wide-band technology (UWB 616; a short-range radio frequency communications technology). Further, certain MPS devices may be equipped to support signaling via acoustic signaling 618, ultrasound 620, or other signaling and/or communications means 622. Certain technologies 610 may be well-suited to certain MPS functionalities 602 while others may more useful in other circumstances. For example, UWB 616 may provide high precision distance measurements, whereas WI-FI 614 (e.g., using RSSI signal strength measurements) or ultrasound 620 may provide “room-level” topology information (e.g., presence detection indicating that a particular MPS device is within a particular room or space of the environment 101). In some examples, combinations of the different technologies 610 may be used to enhance the accuracy and/or certainty of the information derived from the positioning/localization information received from one or more MPS devices via the positioning system application 600. For example, as discussed further below, in some instances, presence detection may be performed primarily using ultrasound 620; however, RSSI measurements may be used to confirm the presence detection and/or provide more precise localization information in addition to the presence detection.

Examples of MPS devices equipped with ultrasonic presence detection are disclosed in U.S. Patent Publication Nos. 2022/0066008 and 2022/0261212, each of which is hereby incorporated herein by reference in its entirety for all purposes. Examples of localizing MPS devices based on RSSI measurements are disclosed in U.S. Patent Publication No. 2021/0099736, which is herein incorporated by reference in its entirety for all purposes. Examples of performing location estimation of MPS devices using WI-FI 614 are disclosed in U.S. Patent Publication No. 2021/0297168, which is herein incorporated by reference in its entirety for all purposes.

In addition to the positioning/localization information itself, some examples of the positioning system application 600 can expose metadata that specifies localization capabilities of the host MPS device, such as precision and latency information and availability of the various underlying capabilities 610. As such, the positioning system application 600 enables the MPS functionalities 602 each to utilize a common set of API calls to identify the localization capability present within their host MPS device and to access positioning/localization information made available through the identified capabilities 610.

As shown in FIG. 6 and discussed above, the positioning system application 600 can interoperate with MPS devices that support a wide variety of localization capabilities, such as BLUETOOTH 612, WI-FI 614, UWB 616, acoustic signaling 618 and/or ultrasound 620, among others 622. In some examples, the positioning system application 600 includes one or more adapters configured to communicate with MPS devices using syntax and semantics specific to the localization capability 610 of the MPS devices. This architecture shields the MPS functionalities 602 from the complexity of interoperating with each type of MPS device. In some examples, each adapter can receive and process a stream of positioning/localization data from the MPS devices using any one or more of the communications capabilities 610. The adapters can interoperate with an accumulation engine within the positioning system application 600 that analyzes and merges (e.g., using a set of configurable rules) positioning/localization data obtained by the adapters and populates data structures that contain the positioning/localization information and the metadata described above. These data structures, in turn, are accessed and the positioning/localization information, and metadata, are retrieved by the positioning system application 600 in response to API calls received by the positioning system application 600 to support the MPS functionalities 602. The positioning/localization information, and metadata, can specify, in some examples, position/location of a device relative to other devices, absolute position/location (e.g., within a coordinate system) of a device, presence of device (e.g., within a structure, room, or as a simple Boolean value), and/or orientation of a device.

For instance, in some examples, the positioning/localization information is expressed in two dimensions (e.g., as coordinates in a Cartesian plane), in three dimensions (e.g., as coordinates in a Cartesian space), or as coordinates within other coordinate systems. In certain examples, the positioning/localization information is stored in one or more data structures that include one or more records of fields typed and allocated to store portions of the information. For instance, in at least one example, the records are configured to store timestamps in association with values indicative of location coordinates of a network device taken at a time given by the associated timestamp. The records may be configured to store various other information as well. Other examples of positioning/localization information, and structures configured to store the same, will be apparent in view of this disclosure.

It should be noted that the API and adapters implemented by the positioning system application 600 may adhere to a variety of architectural styles and interoperability standards. For instance, in one example, the API is a web services interface implemented using a representational state transfer (REST) architectural style. In this example, the API communications are encoded in Hypertext Transfer Protocol (HTTP) along with JavaScript Object Notation and/or extensible markup language. In some examples, portions of the HTTP communications are encrypted to increase security. Alternatively or additionally, in some examples, the API is implemented as a .NET web API that responds to HTTP posts to particular URLs (API endpoints) with localization data or metadata. Alternatively or additionally, in some examples, the API is implemented using simple file transfer protocol commands. Also, in some examples, the adapters are implemented using a proprietary application protocol accessible via a user datagram protocol socket. Thus, the adapters and the API as described herein are not limited to any particular implementation.

### IV. LOCALIZATION OF PLAYBACK DEVICES

As discussed above, aspects and embodiments are directed to monitoring movement of a portable playback device within an environment and optionally implementing one or more media playback system application functionalities, such as altering at least one configuration aspect of the portable playback device, based on the location of the portable playback device. In particular, certain examples are directed to determining the location of a docking station associated with the portable playback device, as discussed further below.

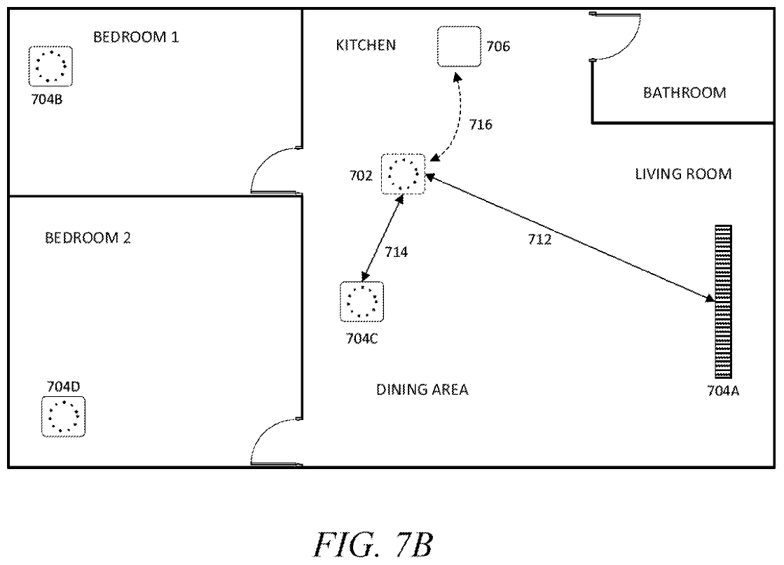

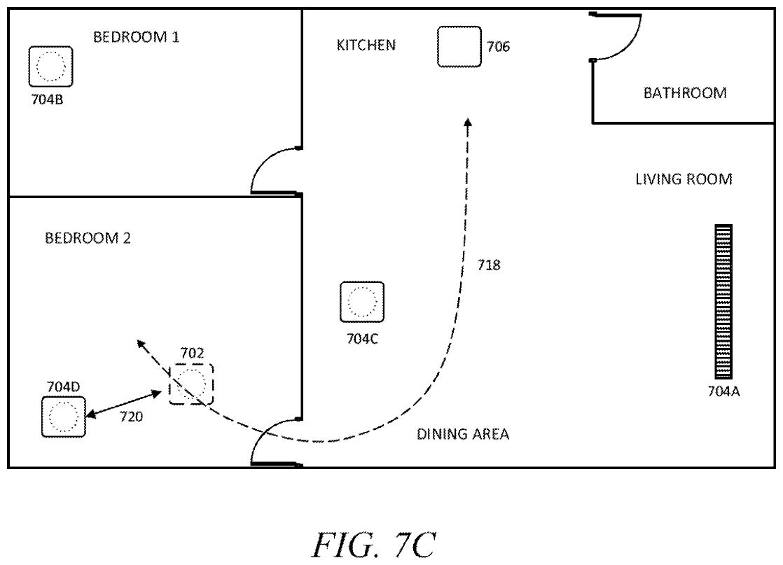

Referring to FIGS. 7A-C, there is illustrated an environment 700 (e.g., environment 101 discussed above) in which a media playback system (e.g., such as MPS 100 discussed above) including a plurality of playback devices is installed and in which movement monitoring systems and methods according to certain examples can be implemented. In the illustrated example, the environment 700 includes several rooms and spaces identified as “Bedroom 1,” “Bedroom 2,” “Kitchen,” “Dining Area,” “Living Room,” and “Bathroom;” however, it is to be appreciated that the environment 700 may include additional, fewer, or other rooms/spaces and the example shown in FIGS. 7A-C is for purposes of illustration only. In the illustrated example, the media playback system includes a portable playback device 702 and four stationary playback devices 704 (identified individually as 704A-D). The stationary playback devices 704 may be playback devices 102, NMDs 103, or NMD-equipped playback devices 102. The media playback system may include additional playback devices, NMDs, and/or controller devices not shown in FIGS. 7A-C. Further, in other examples, the media playback system may include fewer than four stationary playback devices 704. The stationary playback devices 704 may have relatively fixed positions within the environment 700 and in at least certain instances, their locations within the environment 700 and/or relative to one another may be known (e.g., from set-up and/or through various localization techniques).

The portable playback device 702 may be associated with a docking station 706. In the example illustrated in FIGS. 7A-C, the docking station 706 may be located in the Kitchen; however, in certain examples, the docking station 706 may be passive in that it lacks any communications capability by which to report its location to devices of the media playback system. Such a docking station may be referred to as a virtual docking station. Accordingly, as discussed further below, in certain examples, the location of the docking station 706 may be inferred or determined based on information obtained from and about the portable playback device 702.

As the portable playback device 702 is moved around the environment 700, its location can be monitored using a combination of movement information reported by the portable playback device 702 itself and positional information acquired from one or more of the stationary playback devices 704. As described above, the positional information and/or movement information can be expressed, for example, in two dimensions (e.g., as coordinates in a Cartesian plane), three dimensions (e.g., as coordinates in a Cartesian space), or as movement/positions within other coordinate systems. In certain examples, the movement information and/or the positional information is stored in one or more data structures that include one or more records of fields typed and allocated to store portions of the information. For instance, in at least one example, the records are configured to store timestamps in association with values indicative of location coordinates of the portable playback device 702 taken at a time given by the associated timestamp. Further, in at least one example, the records are configured to store timestamps in association with values indicative of velocity of the portable playback device 702 taken at a time given by the associated timestamp. Further, in at least one example, the records are configured to store timestamps in association with values indicative of a segment of movement (starting and ending coordinates) of the portable playback device 702 taken at times given by associated timestamps. Various other examples will be apparent, given the benefit of this disclosure.

In some examples, the stationary playback devices 704 can be configured to detect the presence of the portable playback device 702 when the portable playback device 702 is in their proximity, and provide notifications of that detection. Based on the detection information, positional information about the portable playback device 702 can be determined. For example, the positional information can be determined by an individual stationary playback device that reports the positional information and/or movement information to other playback devices such that multiple playback devices can be updated and/or act on this information directly (or indirectly via an intermediary playback device).

According to certain embodiments, one or more of the stationary playback devices 704 may be designated as a “hub” device that collects the detection information from the stationary playback devices and the movement information provided by the portable playback device 702. In other examples, the portable playback device 702 may be designated as the hub device. The hub device can be configured to determine a relative location of the portable playback device 702 (i.e., location in the environment 700 relative to one or more of the stationary playback devices 704) based on the collected information and take various actions based on the determined location, as discussed in more detail below. In certain examples, one or more of the stationary playback devices 704 may have greater processing capabilities than others of the stationary playback devices, and one of these higher-capability playback devices may be designated as the hub device. Furthermore, designation as the hub device need not be permanent. Different playback devices 702, 704 may be designated as the hub device at different times depending on various factors, including, for example, a state of activity of one or more playback devices. For example, at a certain time, if the stationary playback device 704B is engaged in playback of audio content whereas stationary playback device 704A is not, it may be preferable to designate stationary playback device 704A as the hub device.

To acquire and report the detection information using an appropriate wireless communications and/or sensing capability, the stationary playback devices 704 may each host an instance of the positioning system application 600 discussed above. The portable playback device 702 may also host an instance of the positioning system application 600. Through the positioning system application 600, the portable playback device 702 and/or the stationary playback devices 704 may communicate positional information (e.g., movement information or presence detection information) to the designated hub device for use in support of one or more application functionalities of the media playback system. Alternatively, in some examples, only the hub device may host an instance of the positioning system application 600.

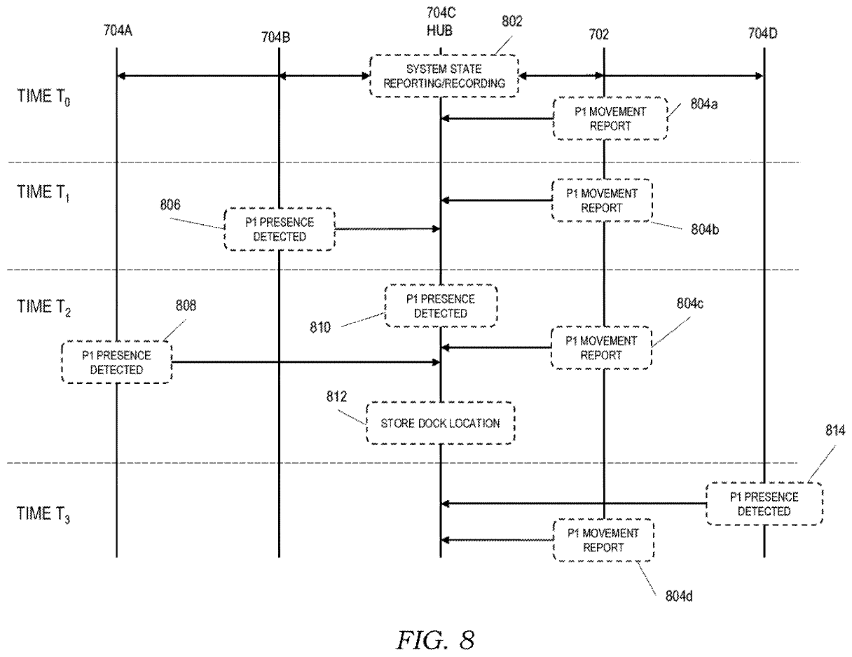

FIG. 8 is an information flow and timing diagram corresponding to an example of movement of the portable playback device 702 in the environment 700 of FIGS. 7A-C. In the example of FIG. 8, the stationary playback device 704C is designated as the hub device; however, given the benefit of this disclosure, those skilled in the art will appreciate that in other examples any of the stationary playback devices 704 or the portable playback device 702 may be the hub device, as discussed above.

Referring to FIG. 8, during time period T₀, various system state information may be communicated between the hub playback device 704C and the other playback devices 702, 704A, 704B, and 704D, as indicated at block 802. The hub playback device 740C may also record system state information received from the other playback devices 702, 704A, 704B, and 704D. In certain examples, the system state information may include an indication that the portable playback device 702 is charging. Such information may indicate both a present lack of movement of the portable playback device and the likelihood that the portable playback device 702 is on its docking station 706. Further system state information may include information that the portable playback device 702 is playing audio content and/or that two or more playback devices 702, 704A-D are playing audio content in synchrony, or that the portable playback device is presently part of a bonded group with one or more stationary playback devices 704. In various examples, the system state information may include any information relating to one or more of the playback devices 702, 704A-D that may be useful in localizing the portable playback device. State information may also include, for example, indicators identifying a network connection status, whether voice activity is present in an environment, or when a user is proximate to a playback device. Other example state information may include indicators of a level of volume, a queue associated with one or more devices, and playback state, such as whether devices are playing a queue, paused, etc.

As shown in FIG. 8, the portable playback device 702 (“P1”) may periodically transmit movement information to the hub playback device 704C (indicated at blocks 804a-d). In some examples, the portable playback device 702 may transmit the movement information at predetermined time intervals, such as every few seconds, milliseconds, minutes, or other time intervals. The time intervals may be regular or irregular. In some examples, the portable playback device 702 may transmit movement information more frequently when it is moving than when it is not moving. In some instances, movement of the portable playback device 702 may trigger transmission of the movement information. Thus, the portable playback device 702 may not transmit movement information when it is stationary, and when it moves, may transmit the movement information continuously or at time intervals with a certain frequency/periodicity.

According to certain embodiments, the portable playback device 702 may include an inertial measurement unit (IMU) that may detect and report positional information for the portable playback device. The IMU may detect linear acceleration of the portable playback device 702 using one or more accelerometers and rotational rate using one or more gyroscopes, for example. The IMU measurements may be used to perform dead reckoning position calculations to track movement of the portable playback device 702 as it is moved through the environment 700. In certain examples, the movement information reported to the hub device from the portable playback device 702 may include the IMU measurement data and/or positional information calculated using the IMU measurement data.

In other examples, the portable playback device 702 may include one or more other sensors and/or systems in addition to or instead of an IMU. For example, the portable playback device 702 may include one or more discrete accelerometers and/or gyroscopes that are not part of an IMU but may be used to collect movement data. The portable playback device 702 may include a global positioning system (GPS) unit to acquire GPS-based positional data either instead of or in addition to IMU and/or other sensor data. As discussed above, regardless of the underlying technology or sensors used to acquire the position measurements, the positioning system application 600 can provide a common interface to accept incoming data from any of various sources and over any of various communications channels or protocols, and coordinate transmission of the movement information to the hub device.

Referring again to FIG. 8 and to FIG. 7A, during time period T₁, the portable playback device 702 may be moved into the area in the environment 700 designated Bedroom 1 where the stationary playback device 704B is also located. Accordingly, as shown in FIG. 8, the stationary playback device 704B may detect the presence of the portable playback device 702, as indicated by arrow 708 in FIG. 7A and block 806 in FIG. 8. The stationary playback device 704B may report the detection information to the stationary playback device 704C acting as the hub device, as shown in FIG. 8. Further, the portable playback device 702 may report its movement information, as indicated at block 804b. Thus, during time period T₁, the hub device may receive both detection information from the stationary playback device 704B and movement information from the portable playback device 702.

During time period T₂, the portable playback device 702 may be moved from Bedroom 1 into the area that includes the Kitchen, Living Room and Dining Area, as indicated by path 710 shown in FIG. 7A. The presence of the portable playback device 702 may now be detected by the stationary playback devices 704A (indicated by arrow 712 in FIG. 7B and block 808 in FIGS. 8) and 704C (indicated by arrow 714 in FIG. 7B and block 810 in FIG. 8). Accordingly, during time period T₂, the stationary playback device 704A may report detection information to the stationary playback device 704C (acting as the hub device), which also acquires additional detection information from its own detection of the presence of the portable playback device 702 indicated at block 810. Further, the portable playback device 702 reports its movement information to the stationary playback device 704C as indicated at block 804c.

According to certain embodiments, presence detection can be accomplished via transmission (by the portable playback device 702) and detection (by one or more stationary playback devices 704) of communications signals, such as audio signals (e.g., using ultrasound) or radio frequency signals (e.g., via WI-FI, BLUETOOTH, UWB, or another radio frequency communications protocol). In certain examples, the portable playback device 702 may be configured to periodically output a presence alert signal that may be detected by one or more of the stationary playback devices 704. In some examples, the portable playback device 702 may output the presence alert signal with the same or similar timing as the transmission of the movement information 804. In other instances, the portable playback device 702 may transmit the presence alert signal more frequently or less frequently than the movement information. In other examples, the portable playback device 702 may transmit the presence alert signal according to a predefined schedule or upon instruction/request by the hub device or another network device in the media playback system.

In certain examples, the presence alert signals are audio signals, such as audio chirps, that can be detected by the microphone(s) (e.g., microphone(s) 222) of nearby NMDs or NMD-equipped playback devices. The audio signals may be ultrasonic signals, for example. An audio signal can be represented by a time-frequency representation, having identifiable acoustic characteristics or patterns (such as one or more tones of particular frequencies or symbols) over time. To enable identification of the transmitting playback device, the time-frequency representation of the audio signal can be unique to each playback device transmitting the audio signal. For example, the audio signal may include an identifier or a code for the playback device playing the audio signal. Each encoded identifier may be different and encoded as a set of tones, for example. Each tone or symbol can be in the form of a pulse where the tone has a duration, envelope length, and a guard interval. The duration of a particular tone can be the time between the beginning and end of the pulse (e.g., 5 -15 milliseconds), and the envelope length can be the length of time that pulse takes to reach maximum magnitude from zero (e.g., 1-10 milliseconds). The guard interval (i.e. an interval of time) is a period of silence between each tone or before the following tone (e.g., 10-50 milliseconds, such as between about 30-50 milliseconds). Thus, upon detection of an audio signal corresponding to a presence alert signal from the portable playback device 702, the receiving stationary playback device 704 can identify the portable playback device 702 as the source of the audio signal. Further examples and details regarding presence detection using audio signals, and in particular, ultrasound signals, are disclosed in U.S. Patent Publication No. 2022/0066008 referenced above.

According to certain examples, presence detection of the portable playback device 702 may be based on line-of-sight signal reception, such as detection of UWB signals emitted by the portable playback device. UWB signals may be used to obtain relatively precise positional information, and therefore may be preferred in some examples. In other examples, the presence alert signals may be radio frequency signals transmitted via WI-FI or BLUETOOTH, for example. According to certain embodiments, it may be preferable to use relatively short-range signals, such as ultrasound, BLUETOOTH, or UWB signals, for presence detection in order to obtain more accurate presence detection and positional information. However, signal strength measurements, such as RSSI measurements, may also be used to increase precision whether short-range or longer-range signal types are used. For example, a stationary playback device 704 that detects higher RSSI for the received presence alert signal may be closer to the portable playback device 702 than one that detects the presence alert signal with lower RSSI. In another example, higher RSSI values may indicate fewer (or no) barriers between the portable playback device 702 and the detecting stationary playback device relative to another stationary playback device that detects the presence alert signal with lower RSSI values.

In certain examples, the detection information may include information in addition to an indication that the presence of the portable playback device 702 was detected. For example, in the example shown in FIG. 7B, the portable playback device 702 is at least temporarily closer to the stationary playback device 704C than to the stationary playback device 704A. This difference in relative position may be determined based on various aspects, such as relative signal strength, for example. In addition, where the presence alert signals emitted by the portable playback device are audio signals, Doppler shift measurements between multiple tones or multiple instances of the presence alert signal may be used to determine whether the portable playback device 702 is moving towards or away from a given stationary playback device 704. U.S. Patent Publication No. 2022/0066008 referenced above discloses examples of determining which playback device out of a plurality of playback devices is closest to a portable playback device using techniques applicable to audio signals and as may be applied to the present disclosure, as will be appreciated by those skilled in the art. Further, US Patent Publication Nos. 2021/0099736 and 2021/0297168 referenced above provide examples of using RSSI measurements to obtain positional information, which may also be applied to the presence detection techniques disclosed herein, as will be appreciated by those skilled in the art. Collecting the presence detection information and movement information over time may allow the stationary playback device 704C to monitor movement of the portable playback device 702 as it is moved around the environment 700.

In certain examples, a combination of multiple communications technologies, such as UWB and ultrasound signals, for example, may be used to obtain more accurate localization information for the portable playback device 702 and monitor its movement paths through the environment 700. In some instances, presence detection may be performed primarily using one communications technology, such as UWB, for example, and a second communications technology, such as ultrasound or RF signals over WI-FI for example, may be used to verify the presence detection as needed. For example, in some instances one or more of the stationary playback devices 704 may detect a very weak presence alert signal, e.g., >=−70 dBm, >=−80 dBm, or >=−90 dBm, from the portable playback device 702, and a secondary signaling method may be used to confirm or reject the presence detection.

Still referring to FIG. 7B, in certain instances, the portable playback device may be moved onto its associated docking station 706, as indicated by path 716 in FIG. 7B. In some instances, when the portable playback device 702 engages with the docking station 706, the portable playback device may provide a docking notification signal. Thus, in some instances the movement information that the stationary playback device 704C receives from the portable playback device 702 may include a docking notification. The stationary playback device 704C may use the docking notification in combination with the collected movement and detection information to infer or estimate the location of the docking station 706 based on the determined location of the portable playback device (determined from the collected movement and detection information) and the knowledge (from the docking notification) that the portable playback device is docked at the determined location. The stationary playback device 704C may store the estimated location of the docking station 706, as indicated by block 812 in FIG. 8.

Referring to FIGS. 7C and 8, during time period T₃, the portable playback device may be moved from the Kitchen/Dining Area (optionally from the docking station 706) into Bedroom 2, as indicated by path 718 in FIG. 7C, where its presence may be detected by the stationary playback device 704D (as indicated by arrow 720 in FIG. 7C). The stationary playback device 704D may report the detected presence of the portable playback device 702 to the stationary playback device 704C, as indicated at block 814 in FIG. 8.

Over time, as the portable playback device 702 is moved about the environment 700, the hub device may continue to collect movement information from the portable playback device 702 and presence detection information from any of the stationary playback devices 704. Based on the collected information, the hub device may update the estimated location of the docking station 706 over time, potentially refining the estimated location as the hub device collects more positional information about the portable playback device 702. In some examples, even if the portable playback device 702 does not provide a docking notification signal when it is docked, the hub device may estimate or infer the location of the docking station 706 by monitoring the movement of the portable playback device 702 over time and determining that the portable playback device 702 repeatedly returns to the same location. The hub device may determine that this same location is the location of the docking station 706.

According to certain embodiments, the hub device may automatically direct the portable playback device 702, and optionally one or more of the stationary playback devices 704, to take a particular action based on the estimated location of the docking station 706 and a determination that the portable playback device is docked. For example, referring to FIGS. 7A-C, the docking station 706 may be in a location such that, when the portable playback device 702 is docked it is positioned such that it can form a stereo pair with the stationary playback device 704C and/or a synchronous group (e.g., for a home theatre arrangement) with the stationary playback devices 704A and 704C. Accordingly, upon determining that the docking station 706 is in a location where such grouping/pairing would be desirable and that the portable playback device 702 is docked, the hub device may automatically direct the appropriate devices to initiate the grouping/pairing, without requiring intervention by a user.

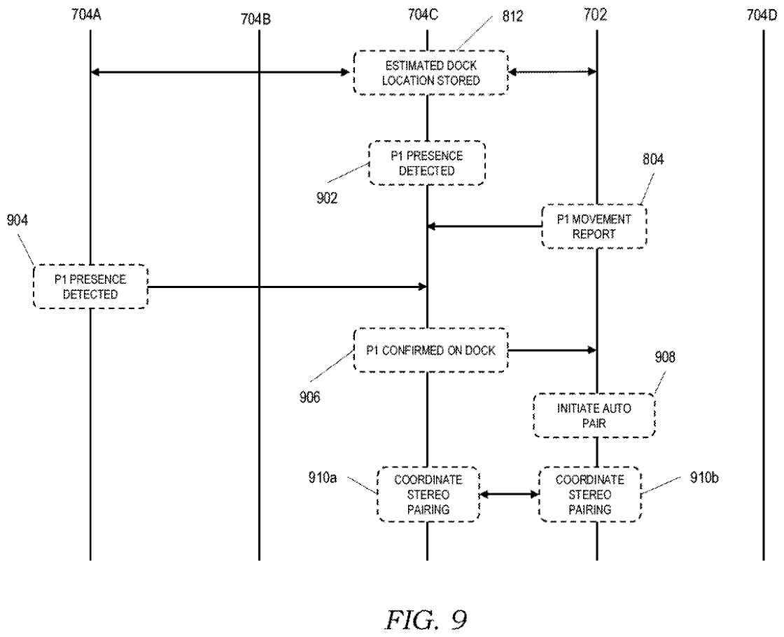

FIG. 9 illustrates an information flow diagram corresponding to one such example in which the portable playback device 702 and the stationary playback device 704C may automatically form a stereo pair. Referring to FIG. 9, the stationary playback device 704C (acting as the hub device in this example as discussed above) may have stored the estimated location of the docking station 706, as indicated at block 812 in FIG. 9 and as discussed above. Considering the example shown in FIG. 7B, when the portable playback device 702 is docked at the docking station 706, its presence may be detected by the stationary playback device 704C (as indicated at block 902 in FIG. 9) and the stationary playback device 704A (as indicated at block 904 in FIG. 9). In addition, the portable playback device 702 may report its movement information (indicated at block 804 in FIG. 9), as discussed above. The movement information may optionally include a docking notification. Based on the collected information from blocks 804, 902, and 904, as well as previously acquired state information and the stored estimated location of the docking station determined from movement and detection information collected previously (as discussed above with reference to FIG. 8), the stationary playback device 704C may confirm that the portable playback device 702 is docked, as indicated at block 906 in FIG. 9. Accordingly, the stationary playback device 704C may direct the portable playback device 702 to initiate automatic pairing, as indicated at block 908. The stationary playback device 704C and the portable playback device 702 may then coordinate stereo pairing as shown at blocks 910a and 910b, and as discussed above with reference to FIG. 3B.

Thus, aspects and embodiments provide network devices, systems, and methods that allow for monitoring the movement of portable playback devices through an environment and making various determinations based thereon. Examples discussed above include estimating the location of the docking station 706; however, various other information may also be derived from monitoring the movement of one or more portable playback devices 702 over time. For example, repeated patterns of movement and use of the portable playback device(s) may be determined. Various automatic actions, such as stereo pairing or grouping, may be initiated based on the portable playback device 702 being localized at a particular location (such as at its docking station 706) where such action would be useful.

### V. CONCLUSION

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only way(s) to implement such systems, methods, apparatus, and/or articles of manufacture.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain aspects of the present disclosure can be practiced without certain, specific details. In other instances, well known methods, procedures, components, and circuitry have not been described in detail to avoid unnecessarily obscuring aspects of the examples and aspects of the present technology. Accordingly, the scope of the present disclosure is defined by the appended claims rather than the forgoing description of examples.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

### VI. EXAMPLES

The present technology is illustrated, for example, according to various aspects described below. Various examples of aspects of the present technology are described as numbered examples for convenience. These are provided as examples and do not limit the present technology. It is noted that any of the dependent examples may be combined in any combination, and placed into a respective independent example. The other examples can be presented in a similar manner.

(Example 1) A playback device comprising: a wireless communications interface configured to support communication of data via at least one network protocol; at least one processor; and at least one non-transitory computer-readable medium storing program instructions that are executable by the at least one processor such that the playback device is configured to: over a time period, periodically receive, via the wireless communications interface, movement information from a portable playback device; over the time period, receive via the wireless communications interface, multiple instances of detection information from at least one stationary playback device, the detection information indicating that the at least one stationary playback device has detected a presence of the portable playback device; estimate a location of a docking station for the portable playback device based on at least the movement information and the detection information; and store the estimated location of the docking station in the at least one non-transitory computer-readable medium.

(Example 2) The playback device of Example 1, wherein the at least one non-transitory computer-readable medium further comprises program instructions that are executable by the at least one processor to control the playback device to: detect the portable playback device at the estimated location; and after detecting the portable playback device at the estimated location, cause the portable playback device to group with the at least one stationary playback device for synchronous playback of audio content via the portable playback device and the at least one stationary playback device.

(Example 3) The playback device of any one of Examples 1-2, wherein the at least one stationary playback device includes a first stationary playback device designated as a member of a stereo pair; and wherein the at least one non-transitory computer-readable medium further comprises program instructions that are executable by the at least one processor to control the playback device to: determine that the portable playback device is connected to the docking station; and automatically instruct the portable playback device to pair with first stationary playback device to form the stereo pair.

(Example 4) The playback device of any one of Examples 1-3, wherein the at least one non-transitory computer-readable medium further comprises program instructions that are executable by the at least one processor to control the playback device to: over a subsequent time period, receive updated detection information from the at least one stationary playback device; and update the location of the docking station based on the updated detection information.

(Example 5) The playback device of any one of Examples 1-4, wherein the program instructions that are executable by the at least one processor such that the playback device is configured to receive the detection information include program instructions that are executable by the at least one processor such that the playback device is configured to: at a first time, receive first detection information from a first stationary playback device, the first detection information indicating that the first stationary playback device has detected a presence of the portable playback device; and at a second time, receive second detection information from a second stationary playback device, the second detection information indicating that the second stationary playback device has detected the presence of the portable playback device.

(Example 6) The playback device of any one of Examples 1-5, wherein the at least one non-transitory computer-readable medium further comprises program instructions that are executable by the at least one processor to control the playback device to: determine, based on the movement information and the detection information, that the portable playback device repeatedly returns to a same location relative to the at least one stationary playback device; and identify the same location as the location of the docking station.

(Example 7) The playback device of any one of Examples 1-5, wherein the program instructions that are executable by the at least one processor such that the playback device is configured to receive the movement information include program instructions that are executable by the at least one processor such that the playback device is configured to receive a docking notification from the portable playback device, the docking notification indicating that the portable playback device is connected to the docking station.

(Example 8) The playback device of any one of Examples 1-7, wherein the at least one non-transitory computer-readable medium further comprises program instructions that are executable by the at least one processor to control the playback device to: detect the presence of the portable playback device; and estimate the location of the docking station based on the movement information, the detection information, and detection of the presence of the portable playback device.

(Example 9) The playback device of any one of Examples 1-8, wherein portable playback device includes an inertial measurement unit, and wherein the program instructions that are executable by the at least one processor such that the playback device is configured to receive the movement information include program instructions that are executable by the at least one processor such that the playback device is configured to receive measurements from the inertial measurement unit.

(Example 10) The playback device of any one of Examples 1-9, wherein the wireless communications interface includes at least one of a WI-FI interface, a BLUETOOTH interface, an ultrasound interface, or an ultra-wideband radio interface.

(Example 11) A method of determining a location of a docking station, the method comprising: over a time period, receiving multiple instances of movement information from a portable playback device; over the time period, receiving multiple instances of detection information from at least one stationary playback device, the detection information indicating that the at least one stationary playback device has detected a presence of the portable playback device; estimating, based on at least a combination of the movement information and the detection information, the location of the docking station relative to the at least one stationary playback device; and storing the location of the docking station.

(Example 12) The method of Examples 11, further comprising: over a subsequent time period, receiving updated detection information from the at least one stationary playback device; and updating the location of the docking station based on the updated detection information.

(Example 13) The method of one of Examples 11-12, wherein estimating the location of the docking station includes: determining, based on the movement information and the detection information, that the portable playback device repeatedly returns to a same location relative to the at least one stationary playback device; and identifying the same location as the location of the docking station.

(Example 14) The method of one of Examples 11-12, wherein at least one instance of the movement information including a docking notification indicating that the portable playback device is connected to the docking station.

(Example 15) The method of any one of Examples 11-14, wherein receiving the detection information comprises: receiving at a first time during the time period, first detection information from a first stationary playback device; and receiving at a second time during the time period, second detection information from a second stationary playback device.

(Example 16) The method of any one of Examples 11-15, further comprising: detecting the presence of the portable playback device; wherein estimating the location of the docking station includes estimating the location of the docking station based on the movement information, the detection information, and detection of the presence of the portable playback device.

(Example 17) The method of any one of Examples 11-15, wherein receiving at least one instance of the detection information includes detecting the presence of the portable playback device.

(Example 18) The method of any one of Examples 11-17, wherein the portable playback device includes an inertial measurement unit, and wherein receiving the movement information from the portable playback device includes receiving measurements from the inertial measurement unit.

(Example 19) The method of any one of Examples 11-18, wherein the portable playback device and the at least one stationary playback device are within an area covered by a wireless network; and wherein receiving the movement information and receiving the detection information include receiving the movement information and the detection information over the wireless network.

(Example 20) The method of any one of Examples 11-19, wherein receiving the movement information and/or receiving the detection information includes receiving the movement information and/or the detection information via at least one of a WI-FI network, a BLUETOOTH connection, an ultra-wideband radio signal, or an ultrasound signal.

(Example 21) The method of any one of Examples 11-20, wherein the at least one stationary playback device includes a first a first stationary playback device designated as a member of a stereo pair; and wherein the method further comprises: determining that the portable playback device is connected to the docking station; and automatically pairing the portable playback device with first stationary playback device to form the stereo pair.

(Example 22) The method of any one of Examples 11-20, further comprising: detecting the portable playback device at the location of the docking station; and after detecting the portable playback device at the location of the docking station, causing the portable playback device to group with the at least one stationary playback device for synchronous playback of audio content via the portable playback device and the at least one stationary playback device.

(Example 23) A method of determining a location of a docking station, the method comprising: over a time period, receiving multiple instances of movement information from a portable playback device; over the time period, receiving multiple instances of detection information from at least one stationary playback device, the detection information indicating that the at least one stationary playback device has detected a presence of the portable playback device; receiving a docking notification from the portable playback device, the docking notification indicating that the portable playback device is connected to the docking station; and estimating, based on a combination of the movement information and the detection information, the location of the docking station relative to the at least one stationary playback device.

(Example 24) The method of Examples 23, wherein receiving the detection information comprises: receiving at a first time during the time period, first detection information from a first stationary playback device; and receiving at a second time during the time period, second detection information from a second stationary playback device.

(Example 25) The method of one of Examples 23-24, further comprising: storing the location of the docking station; receiving at a third time, third detection information from at least one of the first and second stationary playback devices, the third detection information indicating an updated detection of the presence of the portable playback device; and updating the location of the docking station based on the third detection information.

(Example 26) The method of any one of Examples 23-25, further comprising: detecting the portable playback device at the location of the docking station; and after detecting the portable playback device at the location of the docking station, causing the portable playback device to group with the at least one stationary playback device for synchronous playback of audio content via the portable playback device and the at least one stationary playback device.

(Example 27) The method of any one of Examples 23-25, wherein the at least one stationary playback device includes a first stationary playback device designated as a member of a stereo pair; and wherein the method further comprises: determining that the portable playback device is connected to the docking station; and automatically instructing the portable playback device to pair with first stationary playback device to form the stereo pair.

(Example 28) The method of any one of Examples 23-27, wherein portable playback device includes an inertial measurement unit, and wherein receiving the movement information includes receiving measurements from the inertial measurement unit.

(Example 29) A system comprising at least one network device, wherein the at least one network device comprises: a wireless communications interface; at least one processor; and at least one non-transitory computer-readable medium storing program instructions that are executable by the at least one processor such that the at least one network device is configured to: periodically receive, via the wireless communications interface, movement information from a portable playback device; at a first time, receive, via the wireless communications interface, first detection information from a first stationary playback device, the first detection information indicating that the first stationary playback device has detected a presence of the portable playback device; at a second time, receive second detection information from a second stationary playback device, the second detection information indicating that the second stationary playback device has detected the presence of the portable playback device; estimate an estimated location of a docking station for the portable playback device based on at least the first and second detection information and the movement information; and store the estimated location of the docking station in the at least one non-transitory computer-readable medium.

(Example 30) The system of Example 29, wherein the at least one network device comprises a playback device.

(Example 31) The system of one Examples 29-30, wherein the at least one non-transitory computer-readable medium further comprises program instructions that are executable by the at least one processor to control the at least one network device to: at a third time, receive third detection information from at least one of the first and second stationary playback devices, the third detection information indicating an updated detection of the presence of the portable playback device; and update the estimated location of the docking station based on the third detection information.

(Example 32) The system of any one of Examples 29-31, wherein the at least one non-transitory computer-readable medium further comprises program instructions that are executable by the at least one processor to control the at least one network device to: detect the presence of the portable playback device; and estimate the location of the docking station based on the movement information, the first and second detection information, and detection of the presence of the portable playback device.

(Example 33) The system of any one of Examples 29-32, wherein the at least one network device comprises one of the first stationary playback device and the second stationary playback device.

(Example 34) The system of any one of Examples 29-33, wherein the at least one non-transitory computer-readable medium further comprises program instructions that are executable by the at least one processor to control the at least one network device to: detect the portable playback device at the estimated location; and after detecting the portable playback device at the estimated location, cause the portable playback device to group with the one of the first and second stationary playback devices for synchronous playback of audio content via the portable playback device and the one of the first and second stationary playback devices.

(Example 35) The system of any one of Examples 29-33, wherein the first stationary playback device is designated as a member of a stereo pair; and wherein the at least one non-transitory computer-readable medium further comprises program instructions that are executable by the at least one processor to control the at least one network device to: determine that the portable playback device is connected to the docking station; and automatically instruct the portable playback device to pair with first stationary playback device to form the stereo pair.

(Example 36) The system of any one of Examples 29-35, wherein portable playback device includes an inertial measurement unit, and wherein the program instructions that are executable by the at least one processor such that the at least one network device is configured to receive the movement information include program instructions that are executable by the at least one processor such that the at least one network device is configured to receive measurements from the inertial measurement unit.

(Example 37) The system of any one of Examples 29-37, wherein the wireless communications interface includes at least one of a WI-FI interface, a BLUETOOTH interface, an ultrasound interface, or an ultra-wideband radio interface.

(Example 38) A system comprising: a wireless communications interface configured to support communication of data via at least one network protocol; at least one processor; and at least one non-transitory computer-readable medium storing program instructions that are executable by the at least one processor such that the playback device is configured to: over a time period, periodically receive, via the wireless communications interface, movement information from a portable playback device; over the time period, receive via the wireless communications interface, multiple instances of detection information, the detection information indicating that at least one stationary playback device has detected a presence of the portable playback device; estimate a location of a docking station for the portable playback device based on at least the movement information and the detection information; and store the estimated location of the docking station in the at least one non-transitory computer-readable medium.

(Example 39) The system of Example 38, wherein the stationary playback device comprises the wireless communications interface, the at least one processor, and the at least one non-transitory computer-readable medium.

(Example 40) The system of either Example 38 or Example 39, wherein at least one remote computing device comprises the wireless communications interface, the at least one processor, and the at least one non-transitory computer-readable medium.

(Example 41) A method comprising, over a time period, receiving multiple instances of movement information from a portable playback device, over the time period, receiving multiple instances of detection information from at least one stationary playback device, the detection information indicating that the at least one stationary playback device has detected a presence of the portable playback device; and estimating, based on at least a combination of the movement information and the detection information, the location of the docking station relative to the at least one stationary playback device.

(Example 42) The method of Example 41, further comprising, over a subsequent time period, receiving updated detection information from the at least one stationary playback device, and updating the location of the docking station based on the updated detection information.

(Example 43) The method of Example 41 or 42, wherein estimating the location of the docking station includes determining, based on the movement information and the detection information, that the portable playback device repeatedly returns to a same location relative to the at least one stationary playback device; and identifying the same location as the location of the docking station.

(Example 44) The method of any one of Examples 41-43, further comprising storing the location of the docking station.

(Example 45) The method of Example 41 1, wherein receiving the detection information comprises receiving at a first time during the time period, first detection information from a first stationary playback device, and receiving at a second time during the time period, second detection information from a second stationary playback device.

(Example 46) The method of any one of Examples 41-45, further comprising detecting the presence of the portable playback device, wherein estimating the location of the docking station includes estimating the location of the docking station based on the movement information, the detection information, and detection of the presence of the portable playback device.

(Example 47) The method of any one of Examples 41-46, wherein receiving at least one instance of the detection information includes detecting the presence of the portable playback device.

(Example 48) The method of any one of Examples 41-47, wherein the portable playback device includes an inertial measurement unit, and wherein receiving the movement information from the portable playback device includes receiving measurements from the inertial measurement unit.

(Example 49) The method of any one of Examples 41-48, wherein the portable playback device and the at least one stationary playback device are within an area covered by a wireless network, and wherein receiving the movement information and receiving the detection information include receiving the movement information and the detection information over the wireless network.

(Example 50) The method of any one of Examples 41-49, wherein receiving the movement information and/or receiving the detection information includes receiving the movement information and/or the detection information via at least one of a WI-FI network, a BLUETOOTH connection, an ultra-wideband radio signal, or an ultrasound signal.

(Example 51) The method of any one of Examples 41-50, wherein the at least one stationary playback device includes a first a first stationary playback device designated as a member of a stereo pair, and wherein the method further comprises determining that the portable playback device is connected to the docking station, and automatically pairing the portable playback device with first stationary playback device to form the stereo pair.

(Example 52) The method of any one of Examples 41-51, further comprising detecting the portable playback device at the location of the docking station, and after detecting the portable playback device at the location of the docking station, causing the portable playback device to group with the at least one stationary playback device for synchronous playback of audio content via the portable playback device and the at least one stationary playback device.

(Example 53) The method of any one of Examples 41-52, further comprising receiving a docking notification from the portable playback device, the docking notification indicating that the portable playback device is connected to the docking station, wherein estimating the location of the docking station is further based on the received location of the docking station relative to the at least one stationary playback device.

(Example 54) A playback device comprising a wireless communications interface configured to support communication of data via at least one network protocol, at least one processor, and at least one non-transitory computer-readable medium storing program instructions that are executable by the at least one processor such that the playback device is configured to perform the method of any one of Examples 41-53.

(Example 55) The method of any one of Examples 41-53, wherein receiving multiple instances of movement information from the portable playback device comprises periodically receiving, via the wireless communications interface, movement information from the portable playback device, wherein, over the time period, receiving multiple instances of detection information from at least one stationary playback device comprises receiving, at first and second times, via a wireless communications interface, first and second detection information from first and second playback devices, respectively, and wherein estimating an estimated location of a docking station for the portable playback device is based on at least the first and second detection information and the movement information.

(Example 56) The method of any one of Examples 41-53 or 55, further comprising receiving system state information for the portable playback device.

(Example 57) The method of Example 56, wherein the system state information comprises information regarding: a charging state of the portable playback device, an audio playback state of the portable playback device, a network connection status of the portable playback device, user presence information regarding presence of a user in proximity to the portable playback device, a grouping status of the portable playback device, and/or a volume level of the portable playback device, and wherein estimating the location of the docking station is further based on the state information.

(Example 58) The method of any one of Examples 41-53 or 55-57, wherein detecting movement of the portable playback device triggers transmission of the movement information at a higher frequency than before the movement was detected.

(Example 59) A system comprising at least one network device comprising a wireless communications interface configured to support communication of data via at least one network protocol, at least one processor, and at least one non-transitory computer-readable medium storing program instructions that are executable by the at least one processor such that the at least one network device is configured to perform the method of any one of Examples 51-53 or 55-58.

(Example 60) The system of Example 59, wherein the at least one network device comprises a playback device.

(Example 61) The system of Example 59, wherein the at least one network device comprises one of the first stationary playback device and the second stationary playback device.

(Example 62) The system of Example 59, wherein the stationary playback device comprises the wireless communications interface, the at least one processor, and the at least one non-transitory computer-readable medium of the network device.

(Example 63) The system of one of Examples 59 or 60, wherein at least one remote computing device comprises the wireless communications interface, the at least one processor, and the at least one non-transitory computer-readable medium.

1. A method comprising:
over a time period, receiving multiple instances of movement information from a portable playback device;
over the time period, receiving multiple instances of detection information from at least one stationary playback device, the detection information indicating that the at least one stationary playback device has detected a presence of the portable playback device; and
estimating, based on at least a combination of the movement information and the detection information, the location of a docking station relative to the at least one stationary playback device.

2. The method of claim 1, further comprising:
over a subsequent time period, receiving updated detection information from the at least one stationary playback device; and
updating the location of the docking station based on the updated detection information.

3. The method of claim 1, wherein estimating the location of the docking station includes:
determining, based on the movement information and the detection information, that the portable playback device repeatedly returns to a same location relative to the at least one stationary playback device; and
identifying the same location as the location of the docking station.

4. (canceled)

5. The method of claim 1, wherein receiving the detection information comprises:
receiving at a first time during the time period, first detection information from a first stationary playback device; and
receiving at a second time during the time period, second detection information from a second stationary playback device.

6. (canceled)

7. (canceled)

8. The method of claim 1, wherein the portable playback device includes an inertial measurement unit, and wherein receiving the movement information from the portable playback device includes receiving measurements from the inertial measurement unit.

9. The method of claim 1, wherein the portable playback device and the at least one stationary playback device are within an area covered by a wireless network; and
wherein receiving the movement information and receiving the detection information include receiving the movement information and the detection information over the wireless network.

10. The method of claim 1, wherein receiving the movement information and/or receiving the detection information includes receiving the movement information and/or the detection information via at least one of a WI-FI network, a BLUETOOTH connection, an ultra-wideband radio signal, or an ultrasound signal.

11. The method of claim 1, wherein the at least one stationary playback device includes a first stationary playback device designated as a member of a stereo pair; and wherein the method further comprises:
determining that the portable playback device is connected to the docking station; and
automatically pairing the portable playback device with first stationary playback device to form the stereo pair.

12. The method of claim 1, further comprising:
detecting the portable playback device at the location of the docking station; and
after detecting the portable playback device at the location of the docking station, causing the portable playback device to group with the at least one stationary playback device for synchronous playback of audio content via the portable playback device and the at least one stationary playback device.

13. The method of claim 1, further comprising receiving a docking notification from the portable playback device, the docking notification indicating that the portable playback device is connected to the docking station;
wherein estimating the location of the docking station is further based on the docking notification.

14. A playback device comprising:
a wireless communications interface configured to support communication of data via at least one network protocol;
at least one processor; and
at least one non-transitory computer-readable medium storing program instructions that are executable by the at least one processor such that the playback device is configured to:
receive, over a time period and via the wireless communication interface, multiple instances of movement information from a portable playback device,
receive, over the time period and via the wireless communications interface, multiple instances of detection information from at least one stationary playback device, the detection information indicating that the at least one stationary playback device has detected a presence of the portable playback device, and
estimate, based on at least a combination of the movement information and the detection information, a location of a docking station for the portable playback device relative to the at least one stationary playback device.

15. The playback device of claim 14, wherein:
receiving the multiple instances of detection information from the at least one stationary playback device comprises receiving, at first and second times, via a wireless communications interface, first and second instances of detection information from first and second playback devices, respectively; and
estimating the location of the docking station for the portable playback device is based on at least the first and second instances of the detection information and the movement information.

16. The playback device of claim 14, wherein the program instructions comprise program instructions that are executable by the at least one processor to configure the playback device to:
receive, via the wireless communications interface, system state information for the portable playback device.

17. The playback device of claim 16, wherein the system state information comprises information regarding:
a charging state of the portable playback device;
an audio playback state of the portable playback device;
a network connection status of the portable playback device;
user presence information regarding presence of a user in proximity to the portable playback device;
a grouping status of the portable playback device; and/or
a volume level of the portable playback device; and
wherein estimating the location of the docking station is further based on the system state information.

18. The method of claim 8, wherein detecting movement of the portable playback device triggers transmission of the movement information at a higher frequency than before the movement was detected.

19. A system comprising:
at least one network device comprising:
a wireless communications interface configured to support communication of data via at least one network protocol;
at least one processor; and
at least one non-transitory computer-readable medium storing program instructions that are executable by the at least one processor such that the at least one network device is configured to:
receive, over a time period and via the wireless communication interface, multiple instances of movement information from a portable playback device,
receive, over the time period and via the wireless communications interface, multiple instances of detection information from at least one stationary playback device, the detection information indicating that the at least one stationary playback device has detected a presence of the portable playback device, and
estimate, based on at least a combination of the movement information and the detection information, a location of a docking station for the portable playback device relative to the at least one stationary playback device.

20. The system of claim 19, wherein the at least one network device comprises a playback device.

21. The system of claim 19, wherein the at least one network device comprises one of the first stationary playback device and the second stationary playback device.

22. (canceled)

23. (canceled)

24. The system of claim 19, wherein the at least one network protocol includes at least one of a WI-FI network protocol, a BLUETOOTH network protocol, an ultra-wideband radio network protocol, or an acoustic network protocol.

25. The system of claim 19, wherein the at least one stationary playback device includes a first stationary playback device designated as a member of a stereo pair; and
wherein the program instructions include program instructions executable by the at least one processor to configure the network device to:
determine that the portable playback device is connected to the docking station, and
automatically pair the portable playback device with first stationary playback device to form the stereo pair.
